(19) United States
(12) Patent Application Publication
(10) Pub. No.: US 2011/0213623 A1
(43) Pub. Date: Sep. 1, 2011

(54) Disease Management System

(75) Inventors: Barry J. Sender, Mission Viejo, CA (US); Leonard S. Sender, Laguna Beach, CA (US); Adele S. Sender, Laguna Beach, CA (US)

(73) Assignee: Disease Management Services, PLC, Aliso Viejo, CA (US)

(21) Appl. No.: 13/096,150

(22) Filed: Apr. 28, 2011

Related U.S. Application Data
(63) Continuation of application No. 10/597,070, filed on Jul. 10, 2006, now abandoned.
(60) Provisional application No. 60/536,947, filed on Jan. 16, 2004.

(51) Int. Cl. G06Q 50/00; G06Q 10/00

(52) U.S. Cl. 705/2

(57) ABSTRACT

A comprehensive disease management system providing advanced diagnostic, prognostic and therapeutic capabilities to healthcare workers located in remote, rural and resource-poor urban centers is disclosed. Additionally, a method of managing disease in a patient located remotely relative to interpretation and therapeutic dispensing services is provided including methods of data collection, data interpretation and therapeutic dispensing. An algorithm is disclosed to provide non-physician healthcare workers in remote, rural and resource-poor urban centers to manage disease in patients with human immunodeficiency virus (HIV) disease.

### RELATED APPLICATIONS

This application is a continuation of U.S. patent application Ser. No. 10/597,070 filed Jul. 10, 2006 which is a 371 of international patent application PCT/US2005/002103 filed Jan. 14, 2005, which in turn claims priority to U.S. provisional patent application 60/536,947 filed Jan. 16, 2004. The entire contents of each of these applications are incorporated by reference herein.

### COMPUTER PROGRAM LISTING APPENDIX

A computer program listing appendix containing the source code of a computer program that may be used with an embodiment of the present invention is incorporated herein by reference from a compact disk filed in the parent application PCT/US2005/002103 which contained a total of 1 file as follows:

| Date of Creation | Size (Bytes) | Filename |
|---|---|---|
| Jan. 16, 2004 | 3,382 KB | 5202300001 Source Code |

### FIELD OF THE INVENTION

The present invention relates to a comprehensive patient management system. Specifically, the present invention provides advanced diagnostic, prognostic and therapeutic capabilities to healthcare workers located in remote, rural and resource-poor urban centers. More specifically, the present invention provides physician and non-physician healthcare workers access to advanced diagnostic, prognostic and therapeutic capabilities useful for managing patients with chronic diseases, such as human immunodeficiency virus (HIV)-infected persons.

### BACKGROUND OF THE INVENTION

Medical care in developing countries and rural communities presents a challenge to public health officials in that highly efficacious therapies are often not available. In some of these areas the only health care workers available are not physicians but rather nurses or other aid workers who are not trained to prescribe today's complex treatments for many diseases. One disease that has proven to be particularly difficult to manage in resource-poor countries or rural areas is human immunodeficiency virus (HIV) infection/Acquired Immune Deficiency Syndrome (AIDS) or HIV-related disease.

Human immunodeficiency virus was first identified in 1981 and has since spread in epidemic proportions throughout the world. In the early years, the diagnosis of AIDS was an automatic death sentence, and the scientific community embarked on an aggressive search for a vaccine and a cure.

While these goals are still elusive, treatments have been devised that have resulted in HIV/AIDS becoming a treatable, chronic disease. Anti-retroviral drugs are taken in various combinations and according to a range of schedules, for the remainder of the patients' lives. This regime is called High Activity Anti-Retroviral Therapies (HAART; also known as Anti-Retroviral Therapy [ART or ARV]). The ideal result is a lowering of the virus in the bloodstream to undetectable amounts. In this case, the patients' immune systems recover, or do not deteriorate, and they can live healthy and productive lives. This scenario is a reality for most in the USA, Canada and Europe. These developed countries have the political will to deal with this disease, and a complex medical infrastructure to diagnose and treat their population. The public health message of prevention is also emphasized. In addition, from a public health standpoint, it is hypothesized that lowering many individual's viral load effectively lowers the viral load of the entire community and may slow transmission.

In stark contrast, many developing countries across Africa, Asia and South America have unsophisticated medical infrastructure. South Africa, for example, holds the dubious distinction of having the highest AIDS infection rate/death rate in the world, with other southern African nations in close contention. In late 2003, the South African Government released a plan to roll out HAART as part of an HIV/AIDS management plan.

South Africa has become an example for how devastating the AIDS epidemic can become when left unchecked. In this area of Africa, HIV is primarily transmitted through unprotected heterosexual sex. It can take many years for a person infected with HIV to become ill. During this period, sexually active adults spread the virus through the population; HIV is also transmitted from mother to infant in utero. Once a patient's immune system begins to deteriorate to full-blown AIDS, they easily contract opportunistic infections like tuberculosis, pneumonia and cancer. A significant proportion of the South African Department of Health (“DOH”) budget of US$3 billion is currently spent on treating these secondary diseases with costly hospitalization and medication.

Without the rollout of an HIV/AIDS management plan which includes universal access to HAART, by 2008 the current life expectancy for a South African male will fall from 54 to 36 years, and the estimated number of AIDS orphans will rise from 420,000 to 1.6 million. The social cost is a catastrophe of grave proportion; the indirect economic cost would be a devastating 17% (US$22 billion) of the South African GNP.

The health care budget of the DOH currently spent on treating the opportunistic diseases and end-stage infection could more effectively be focused on providing HAART to the infected population as an integral part of a comprehensive management plan. The factors that prevented aggressive HAART treatment of the infected population in South Africa in the past are complex. Recent legal developments have obliged the DOH to administer the anti-viral drug Nevirapine to pregnant mothers and their newborn babies, and settlement has been reached regarding patents of many of the anti-viral drugs. Even as the political will has evolved toward an aggressive management plan, there is limited infrastructure to administer HAART to the urban population, even less so to those dispersed in remote rural areas.

### SUMMARY OF THE INVENTION

The present invention provides a therapeutic management system comprising advanced diagnostic, prognostic and therapeutic capabilities to healthcare workers located in remote, rural and underdeveloped urban centers. More specifically, the present invention provides non-physician healthcare workers access to advanced diagnostic, prognostic and therapeutic capabilities useful for managing diseases including, but not limited to, human immunodeficiency virus (HIV) infection and Acquired Immune Deficiency Syndrome (AIDS). The present invention provides a practical solution to managing disease in remote resource-poor population centers by providing individualized patient care without having highly trained infectious disease physician specialists located at each site.

The algorithm and database of the system of the present invention, updated regularly with state-of-the-art diagnostic protocols and therapeutic regimens, directs the non-physician healthcare worker's selection of diagnostic tests and instructs them as to what medical procedures to conduct. Additionally, the system of the present invention provides continually revised and updated instructions to the healthcare worker based on the new patient data entered after each clinic visit. The system of the present invention additionally provides systems for medication disbursement and other ancillary services to the patient.

In developed countries, even though sophisticated medical infrastructures may already exist, there are limitations to their efficiencies and availability. Managed care organizations, for example, as well as publicly-funded health systems, will all benefit from the cost-control, data collection and the comprehensive, current, state-of-the-art disease management system offered by the present invention.

In one embodiment of the present invention, a disease management system is provided comprising data collection means, data interpretation means and therapeutic dispensing means. The data collection means is used to obtain disease state information from a patient having a disease when the patient is located remotely relative to the data interpretation means and the therapeutic dispensing means. The interpretation means is located on a computer-readable medium and provides diagnostic, prognostic and therapeutic information useful for the management of the patient's disease.

In another embodiment of the present invention, the data collection means is a non-physician healthcare worker or a laboratory.

In an embodiment of the present invention, the data interpretation means is an algorithm or a physician specialist.

In another embodiment of the present invention, the therapeutic dispensing means is a pharmacy.

In yet another embodiment of the present invention, the computer-readable medium can be a hard drive, floppy disk, CD-ROM, zip drive or flash drive.

In an embodiment of the present invention, the disease is human immunodeficiency (HIV) disease or acquired immune deficiency syndrome (AIDS) and the patient is a human.

In another embodiment of the present invention, the data interpretation means is the algorithm of FIG. 4.

In an embodiment of the present invention, an HIV-related disease management system is provided including a data collection means for collecting data, a data interpretation means for interpreting data and a therapeutic dispensing means for providing therapy useful for treating HIV-related disease, wherein the data collection means is used to obtain disease state information from a patient having a HIV-related disease. In one embodiment of the present invention, the patient is located remotely relative to the data interpretation means and the therapeutic dispensing means and the data interpretation means is located on a computer-readable medium and provides diagnostic, prognostic and therapeutic information useful for the management of the patient's disease. In another embodiment of the present invention, the data includes patient history and CD4 levels. In yet another embodiment of the present invention, the therapy is High Activity Anti-Retroviral Therapy (HAART).

In an embodiment of the present invention, a method for managing disease in a patient located remotely relative to a data interpretation means and a therapeutic dispensing means is provided comprising collecting a first set of data from the remotely located patient, interpreting the first set of data in order to determine an appropriate first therapeutic regimen for the remotely located patient, dispensing the first therapeutic regimen to the remotely located patient, collecting at least one second set of data from the remotely located patient and interpreting the at least one second set of data in order to determine the appropriateness of continuing or stopping the first therapeutic regimen or altering the first therapeutic regimen for the remotely located patient. In another embodiment of the present invention, the first and at least one second interpreting step comprises an algorithm located on a computer-readable medium that provides diagnostic, prognostic and therapeutic information useful for the management of disease in patients. In another embodiment of the present invention, the disease is HIV disease or AIDS.

In another embodiment of the present invention, the data is collected by a non-physician healthcare worker or a laboratory.

In an embodiment of the present invention, the data interpretation means is an algorithm or a physician specialist. In another embodiment of the present invention, the therapeutic dispensing means is a pharmacy.

In yet another embodiment of the present invention, the computer-readable medium can be a hard drive, floppy disk, CD-ROM, zip drive or flash drive.

In an embodiment of the present invention, a method for disease management is provided including collecting data, interpreting data and dispensing a therapeutic useful for treating disease, where the interpretation of data is performed according the algorithm of FIG. 4.

### BRIEF DESCRIPTION OF THE DRAWINGS

FIG. 1 graphically depicts a flow chart of an illustrative embodiment of the operating system loop of the disease management system of the present invention.

FIG. 2 is an assessment form for evaluating readiness for Anti-Retroviral Therapy (ART) that may be utilized in one embodiment of the disease management system of the present invention. FIG. 2.1 and FIG. 2.2 are the same form. FIG. 2.2 is a continuation of FIG. 2.1.

FIG. 3 is a follow-up form for ART that may be utilized in one embodiment of the disease management system of the present invention. FIG. 3.1 and FIG. 3.2 are the same form. FIG. 3.2 is a continuation of FIG. 3.1.

FIG. 4 illustrates the main flow algorithm representing an Human Immunodeficiency Virus (HIV)/Acquired Immunodeficiency Syndrome (AIDS) embodiment of the disease management system of the present invention. FIGS. 4.1, 4.2 and 4.3 are three pages of the same figure.

FIG. 5 illustrates the “Determine Age Category” sub-algorithm of the HIV/AIDS embodiment of the disease management system of the present invention.

FIG. 6 illustrates the “Confirm HIV Status” sub-algorithm of the HIV/AIDS embodiment of the disease management system of the present invention.

FIG. 7 illustrates the “Determine HAART Candidate” sub-algorithm of the HIV/AIDS embodiment of the disease management system of the present invention.

FIG. 8 illustrates the “HAART Candidate Readiness” sub-algorithm of the HIV/AIDS embodiment of the disease management system of the present invention.

FIG. 9 illustrates the “Status Active TB” sub-algorithm of the HIV/AIDS embodiment of the disease management system of the present invention.

FIG. 10 illustrates the “Status Latent TB” sub-algorithm of the HIV/AIDS embodiment of the disease management system of the present invention.

FIG. 11 illustrates the “TB Prophylaxis” sub-algorithm of the HIV/AIDS embodiment of the disease management system of the present invention.

FIG. 12 illustrates the “Isoniazid” sub-algorithm of the HIV/AIDS embodiment of the disease management system of the present invention.

FIG. 13 illustrates the “Efivarenz” sub-algorithm of the HIV/AIDS embodiment of the disease management system of the present invention.

FIG. 14 illustrates the “Contraindications Efivarenz” sub-algorithm of the HIV/AIDS embodiment of the disease management system of the present invention.

FIG. 15 illustrates the “Nevirapine” sub-algorithm of the HIV/AIDS embodiment of the disease management system of the present invention.

FIG. 16 illustrates the “Contraindications Nevirapine” sub-algorithm of the HIV/AIDS embodiment of the disease management system of the present invention.

FIG. 17 illustrates the “Stavudine” sub-algorithm of the HIV/AIDS embodiment of the disease management system of the present invention.

FIG. 18 illustrates the “Contraindications Stavudine” sub-algorithm of the HIV/AIDS embodiment of the disease management system of the present invention.

FIG. 19 illustrates the “Lamivudine” sub-algorithm of the HIV/AIDS embodiment of the disease management system of the present invention.

FIG. 20 illustrates the “Zidovudine” sub-algorithm of the HIV/AIDS embodiment of the disease management system of the present invention.

FIG. 21 illustrates the “Contraindications Zidovudine” sub-algorithm of the HIV/AIDS embodiment of the disease management system of the present invention.

FIG. 22 illustrates the “Didanosine” sub-algorithm of the HIV/AIDS embodiment of the disease management system of the present invention.

FIG. 23 illustrates the “Contraindications Didanosine” sub-algorithm of the HIV/AIDS embodiment of the disease management system of the present invention.

FIG. 24 illustrates the “Lopinavir/Ritanovir” sub-algorithm of the HIV/AIDS embodiment of the disease management system of the present invention.

FIG. 25 illustrates the “Contraindications Lopinavir/Ritanovir” sub-algorithm of the HIV/AIDS embodiment of the disease management system of the present invention.

FIG. 26 illustrates the “Cotrimoxazole” sub-algorithm of the HIV/AIDS embodiment of the disease management system of the present invention.

FIG. 27 illustrates the “Status Liver” sub-algorithm of the HIV/AIDS embodiment of the disease management system of the present invention.

FIG. 28 illustrates the “Status Anemia” sub-algorithm of the HIV/AIDS embodiment of the disease management system of the present invention.

FIG. 29 illustrates the “Status Neutrophils” sub-algorithm of the HIV/AIDS embodiment of the disease management system of the present invention.

FIG. 30 illustrates the “Status Pancreas” sub-algorithm of the HIV/AIDS embodiment of the disease management system of the present invention.

FIG. 31 illustrates the “Status Kidney” sub-algorithm of the HIV/AIDS embodiment of the disease management system of the present invention.

FIG. 32 illustrates the “Status Malnutrition” sub-algorithm of the HIV/AIDS embodiment of the disease management system of the present invention.

FIG. 33 illustrates the “Status Regimen lab Effectiveness” sub-algorithm of the HIV/AIDS embodiment of the disease management system of the present invention.

FIG. 34 illustrates the “Status Regimen 2 Effectiveness” sub-algorithm of the HIV/AIDS embodiment of the disease management system of the present invention.

FIG. 35 illustrates the “Status Adherence” sub-algorithm of the HIV/AIDS embodiment of the disease management system of the present invention.

FIG. 36 illustrates the “Status Regimen Effectiveness” sub-algorithm of the HIV/AIDS embodiment of the disease management system of the present invention.

FIG. 37 illustrates the “Master Patient” computer screen shot of the HIV/AIDS embodiment of the Disease Management System of the present invention.

FIG. 38 illustrates the “Clinical Data Form,” part 1, computer screen shot of the HIV/AIDS embodiment of the disease management system of the present invention.

FIG. 39 illustrates the “Clinical Data Form,” part 2, computer screen shot of the HIV/AIDS embodiment of the disease management system of the present invention.

FIG. 40 illustrates the “Clinical Data Form,” part 3, computer screen shot of the HIV/AIDS embodiment of the disease management system of the present invention.

FIG. 41 illustrates the “Clinical Data Form,” part 4, computer screen shot of the HIV/AIDS embodiment of the disease management system of the present invention.

FIG. 42 illustrates the “HAART Prep Form” computer screen shot of the HIV/AIDS embodiment of the disease management system of the present invention.

FIG. 43 illustrates the “Labs Form,” part 1, computer screen shot of the HIV/AIDS embodiment of the disease management system of the present invention.

FIG. 44 illustrates the “Labs Form,” part 2, computer screen shot of the HIV/AIDS embodiment of the disease management system of the present invention.

FIG. 45 illustrates the “Patient Flow Analysis” computer screen shot of the HIV/AIDS embodiment of the disease management system of the present invention.

FIG. 46 illustrates the “Patient Flow Analysis Report” computer screen shot of the HIV/AIDS embodiment of the disease management system of the present invention.

FIG. 47 illustrates the “Display Patient” computer screen shot of the HIV/AIDS embodiment of the disease management system of the present invention.

FIG. 48 illustrates the “Appointment Status” computer screen shot of the HIV/AIDS embodiment of the disease management system of the present invention.

FIG. 49 illustrates the “Analytics” computer screen shot of the HIV/AIDS embodiment of the disease management system of the present invention.

FIG. 50 illustrates the “Display Log” computer screen shot of the HIV/AIDS embodiment of the disease management system of the present invention.

### DETAILED DESCRIPTION OF THE INVENTION

The present invention provides advanced diagnostic, prognostic and therapeutic capabilities to healthcare workers located in remote, rural and underdeveloped urban centers. More specifically, the present invention provides non-physician healthcare workers access to advanced diagnostic, prognostic and therapeutic capabilities useful for managing diseases including, but not limited to, human immunodeficiency virus (HIV) disease and Acquired Immune Deficiency Syndrome (AIDS). The present invention provides a practical solution to managing disease in remote resource-poor population centers by providing individualized patient care without having highly trained infectious disease physician specialists located at each site.

Human immunodeficiency virus causes a complicated life-threatening infection that is presented in this application as a non-limiting example of the scope of the disease management system of the present invention. Human immunodeficiency virus infection presents as a complex multi-factorial disease that is challenging to manage even in modern urban centers where state-of-the-art teaching hospitals and highly trained physician specialists are readily available. Patient management becomes considerably more difficult when infected individuals are located in underdeveloped urban centers and remote rural locations (herein after referred to as remote patient management). Remote patient management is further exacerbated when the most highly trained healthcare worker is, for example, a community nurse or Red Cross-Red Crescent aid-worker.

In many remote patient management environments, laboratory facilities, pharmacies and diagnostic imaging facilities are located hundreds of miles away. Moreover, even when these facilities are located within a reasonable proximity, patient transportation to and from testing and drug dispensing centers may be unavailable or at best unreliable.

Persons infected with HIV can often have a series of HIV-related diseases which require regular medical evaluations in order to monitor disease progression and therapy efficacy. Test interpretation and therapeutic recommendations often require the expertise of a trained infectious disease specialist. Consequently, persons located in remote patient management environments are less likely to volunteer for testing for HIV because they have learned from experience that treatment options are not readily available. Therefore, there is no benefit to the patient to know their HIV status. As a result, a culture of fear and ignorance has proliferated in underdeveloped urban centers and remote rural locations that feed an ever growing HIV pandemic.

The present invention provides a solution to the problem of unavailability of specialized medical services in underdeveloped urban centers and rural locations. Recent telecommunication advances have made modem access to centralized computer databases available even in the most remote and disadvantaged areas. The present invention utilizes this global communication phenomena to bring cutting edge patient management tools directly to the patient. In one embodiment of the present invention, a non-physician healthcare worker is provided with questionnaires and protocols developed by physician experts. Using these tools, combined with rudimentary physical examination skills, the non-physician healthcare worker becomes a virtual infectious disease diagnostician. Answers to the patient questionnaire and the results of the physical examination are entered into the database locally or remotely and the algorithm feature of the present invention collates and analyzes the individualized patient data. Appropriate biological samples, principally blood, are collected and sent to a designated testing facility where the samples are tested and the results are entered into the same database and the algorithm of the present invention applied. Based on the combined results of the laboratory tests, questionnaire and physical examination, a preliminary diagnosis is established and an appropriate treatment regimen proposed. As used herein, an appropriate treatment regimen is defined as any treatment which a person skilled in the art of disease management would consider useful in the management of patient's disease state. In a non-limiting example, HAART is an appropriate therapeutic regimen for a patient suffering from HIV disease. Patients presenting with symptoms consistent with secondary infections or disorders can then be further examined and additional tests run as indicated, or referred to tertiary centers.

Each time the patient is examined and tested the resulting data is collated, entered and analyzed by the algorithm of the present invention. The non-physician healthcare worker is then provided with an individualized prognostic determination and recommended changes to the therapeutic regimen if required. Consequently, persons in resource-poor urban centers and remote rural settings will now have access to modern diagnostic, prognostic and therapeutic capabilities similar to those available to citizens of countries with sophisticated health care systems. The system of the present invention provides training to the non-physician healthcare worker thereby improving healthcare in general.

Thus, the system of the present invention offers an elegant and practical solution which will allow, as an example, wide and cost-effective High Activity Anti-Retroviral Therapy (HAART, ART or ARV) for HIV/AIDS in the developing world. In an illustrative embodiment, a national or regional health agency in a country in need of disease management support will use the HIV/AIDS disease management system of the present invention that includes transport of blood samples to laboratories, input of data, drug prescription generation and dispensing, as well as psychosocial and nutrition support, education and pharmacovigilance.

Laboratory services, data input, drug packaging and drug dispensing currently exist in many countries and disadvantaged areas, but not as part of an integrated system. The importance of offering national or regional health agencies an integrated management package cannot be overemphasized. In addition, the collection of data that this system facilitates is invaluable for financial, demographic and scientific projections.

Data collection using the disease management system of the present invention also provides critical pharmacovigilance information. Adverse drug reactions can be frequent or rare but information on these reactions is critical in disease management by physicians or non-physician healthcare workers. Once data is collected by the system of the present invention and analyzed by algorithms disclosed as embodiments of the present invention, the data is collected into a pharmacovigilance database where it is available to influence future drug therapy regimens.

Pharmacovigilance embodiments of the system of the present invention include:
determine the burden of drug-related morbidity and mortality in patients
provide training and information to healthcare workers and patients on the safe use of drugs
provide information on risks and benefits of disease treatments, including over the counter medications.
identify, assess and communicate new safety concerns associated with the use drugs
minimize the impact of misleading or unproven associations between adverse events and drug therapy
to detect, assess and respond to safety concerns related to complementary, alternative and traditional medicines
to establish an early warning system for resistance to drugs
to respond to unfounded and unsubstantiated claims of efficacy of untested products and treatment modalities.

In an illustrative embodiment, the present invention includes a specialized algorithm to assist health care workers with the medication management of HIV/AIDS and related opportunistic infections such as tuberculosis (TB). The major features of the disease management system of the present invention include:
medication protocols for specific/individual patients based on evidence-based treatment algorithms
seamless, rapid implementation of new drug protocols
support and tracking of drug reaction mitigation
tracking of drug resistant viral mutations
treatment regardless of geographic location and distance from urban centers
automatic monitoring of high-risk patients
complex cases referred for medical specialist consultation
pharmacovigilance—tracking and monitoring of adverse reactions to HAART or ART
reliable geographic health statistics for public and private sector health planners

In one embodiment of the present invention, an algorithm provides a disease management system for HIV/AIDS using approved anti-retroviral treatment protocols. The algorithms of the present invention:
are based on World Health Organization (WHO) standards
are easily modifiable to accommodate local standards
recommend a treatment protocol as approved by local payors/government
monitor and report the patient's immune function
monitor and report adverse events and drug reactions
alert clinical staff to clinical parameters outside of normal
schedule appointments
schedule and monitors laboratory tests and medical procedures
schedule delivery of pre-packaged drugs
monitor and report compliance with drug regimen

Among the benefits which may be obtained by the system of the present invention are that public and private healthcare service workers will be enabled to implement and operate a cost-effective system to diagnose and treat patients with HIV/AIDS and related diseases. This will hold true even within limitations of poor medical infrastructure. This system does not require significant increase in the number of doctors needed to treat disease and can coexist with many of the present treatment systems. Such a system will effectively result in a reduction in opportunistic infection rates, as well as lower overall usage of medical services by patients. The algorithm of the present invention is an effective tool to ensure accurate and cost effective treatment of HIV/AIDS patients. Medically, the resultant compliance with, and monitoring of, treatment regimes helps prevent drug resistance and disease progression, which require more expensive treatment.

In an illustrative embodiment, the system of the present invention will provide the medical community and governmental agencies, in both the public and private healthcare sectors, with a comprehensive and flexible management plan for the treatment of disease, including HIV/AIDS. At the core of the plan is an interactive system that uses algorithms to direct health care workers in the medical management of complex diseases. The complete plan will allow workers to implement and operate a high quality, cost effective system to diagnose and treat patients while gathering invaluable data. The system is effective even within the limitations of poor medical infrastructure. The system has the ability to supply the tools for meaningful change in social and medical policy in the developing world, as well as to enhance care in the developed world.

The system of the present invention offers a complete integrated healthcare solution. The system integrates laboratory services and medication dispensing in countries that cannot currently deliver comprehensive integrated care for a multitude of diseases due to poor or inefficient healthcare infrastructure.

In an illustrative embodiment, the system of the present invention will be able to take advantage of many developing country's policy initiatives in disease management. For example, the South African government recent issued a policy statement recommending HAART as part of the comprehensive treatment of HIV/AIDS. The system of the present invention can be implemented as a collaborative effort to provide high quality cost-effective healthcare in a timely manner, in accordance with national or regional health agencies' strategy.

Developing countries are resource poor in their medical infrastructure and thus have a low number of medical personnel. South Africa, as a non-limiting example, has a limited number of doctors in general, and infectious disease specialists in particular, as well as nurses and other primary health care workers. This is true in both the rural and urban settings, even within larger tertiary hospitals. In rural primary healthcare clinics the highest qualified healthcare worker is typically a nurse. The innovation of the present invention will enable the resource-poor settings to act as if a specialist were present.

The present invention will dramatically improve the efficiency of the primary health care system to deliver care to its constituency, both in the urban areas, and to the large percentage of the population that live in rural conditions. The primary health care nurses, with the innovative support of the system, can more efficiently provide care for a larger number of patients, and only those who fall outside of the parameters of the algorithm will need to be referred to hospitals or medical specialists.

The challenge of compliance with complex drug therapy regimens is faced in both developing and developed countries, and is enhanced in uneducated populations. This lack of compliance in HIV/AIDS, for example, is particularly dangerous due to the resultant development of resistant HIV, as well as opportunistic diseases associated with AIDS. This system is innovative in its approach to increased compliance by enhancing monitoring, systematic feedback and automated recordkeeping. In addition to the clinical education provided directly to the patient, the system will note deviations in patterns that indicate low compliance, either through altered immune response, or missed appointments. Communicating this information to the local health care worker will facilitate intervention and increased compliance.

The system of the present invention allows all personnel and patients to benefit from advances in the treatment of disease. This is a rapidly evolving field, with advances in all areas, from pharmaceuticals to education interventions, being published on an ongoing basis. As these changes are vetted by, for example, a medical advisory board, and approved by the governmental authorities, they can be implemented almost immediately in the remotest rural location by altering criteria in the central algorithm. One aspect of the novelty of the invention lies in the flexibility inherent in its design to deal with the rapidly evolving science. On the level of the individual patients, the system will enable a rapid response to their changing treatment needs, such as in the development of resistance, or toxicity from anti-retroviral drugs.

For example, HIV-positive patients who are medically eligible for anti-retroviral therapy but do not receive it, are highly susceptible to life-threatening opportunistic infections. These infections are very expensive to treat with costly hospitalization. In a non-limiting example, the innovative efficiency of the system of the present invention will allow resource-poor countries to institute widespread HAART and other therapies keeping patients healthy, productive and out of hospital for significant periods of time and thereby prevent many of these opportunistic infections. The system will thus provide remarkable cost-saving to both the health system and society at large. The system will also be able to cope with multiple disease conditions prevalent in developing countries, in particular HIV/AIDS in combination with tuberculosis and malaria. The system will optimize resources and minimize costs in providing treatment to patients suffering any combination of these diseases. Furthermore, as knowledge of disease pathology increases, patients who are successfully treated may be able to reduce their drug intake for periods of time resulting in increased quality of life for patients and significant cost savings compared to conventional treatment regimes.

The increased compliance that the system facilitates can reduce the number of patients who become resistant to first-line therapy and who need to progress to more expensive, and less effective, alternate regimens.

Additionally, the system of the present invention provides for enhanced data collection and utilization. The tracking capability of the system will create a valuable statistical database. It will have a complete record of each individual's treatment, as well as tracking for each clinic, geographical area, drug performance, toxicity, and every other variable within the system. This data can be utilized for budgetary extrapolations, as well as identifying trends in the disease and its management. An additional use is in the trials for new technology and pharmaceuticals. The data on individual clinics and regions can be used for quality control, and to assess the necessity for re-allocation of financial, staffing or training resources.

In an illustrative embodiment, the computer algorithm of the system of the present invention resides outside of developing countries, and is hosted in a “round the clock” facility to allow for time-zone variances. Algorithm rule sets are designed and implemented to be culture-specific, country-specific and region-specific, and easily adapted to the most current scientific and medical knowledge as agreed to by the provider.

In another illustrative embodiment, the system of the present invention includes a multi-tiered fully redundant highly available architecture. The system is able to accept input from a variety of existing sources, such as client computers running programs including, but not limited to, the various Windows, Unix or Linux desktop operating systems, laboratory-based computer systems, voice interactive systems and other potential devices including cell phones or specialized medical diagnostic devices. Various communication protocols including, but not limited to, TCP/IP are used to communicate to the servers. The servers may be based locally and/or remotely and are also run in a fully redundant and recoverable manner using current standard computing standards. The servers utilize database systems including, but not limited to, Oracle or Microsoft SQL or IBM DB II. A variety of programming tools, languages and interfaces are used to implement the solution including, but not limited to, C#, C++, Visual Basic, HTML, XML, SSL, Data Base queries, Visio and add-on packages are used in development of the system. A proprietary source code is utilized in the system of the present invention and which can be found in the computer program listing appendix filed on compact disk with this application. The multi-tiered architecture and database design implements a security architecture to provide safeguards to protect the algorithms and patient information from being accessed in a malicious or unauthorized manner. All transactions are logged and tracked and communications are encrypted using the latest standards including 48 bit SSL or 128 bit where possible. The database servers and application servers are placed behind a firewall and use industry accepted standards to protect against unauthorized access.

The system algorithm of the present invention is built upon a state-of-the-art medical knowledge database. The most current peer-reviewed treatment protocols are included. The system supports customizations from end-users and local healthcare personnel to ensure that local requirements are taken into account. The system includes a focus on education, communication and prevention options that are integrated with the algorithm implementation. The system is capable of integrating input from existing local grass-roots healthcare workers which enhances enrollment levels as well as compliance levels.

One of the benefits of the system of the present invention is a minimal reliance on data management and control by healthcare workers. In an illustrative embodiment, healthcare workers and service providers enter data into the system via a computer or like technology. Modem access to centralized computer databases can be achieved, for example, via cell phone. In the alternative, laptops, desktops, or hand-held devices with modem access via land line or satellite link or other telecommunication means known to those of skill in the art can be utilized. In one non-limiting embodiment of the present invention, healthcare workers at remote location communicate with a centralized call center using text messaging technology (short message service, SMS). In an additional embodiment, if no computerized or wireless technology is available, paper forms can travel to the lab with the blood specimen for centralized data input.

The medical algorithms of the present invention are constantly evaluated and updated to be current with the most recent clinical recommendations. The system considers and incorporates international state-of-the art treatments, and takes into account specific local conditions. The system also has the capability to work within, and with respect to, the existing culture and traditional society. Input from local leaders and healthcare workers can be incorporated to maximize local acceptance and compliance.

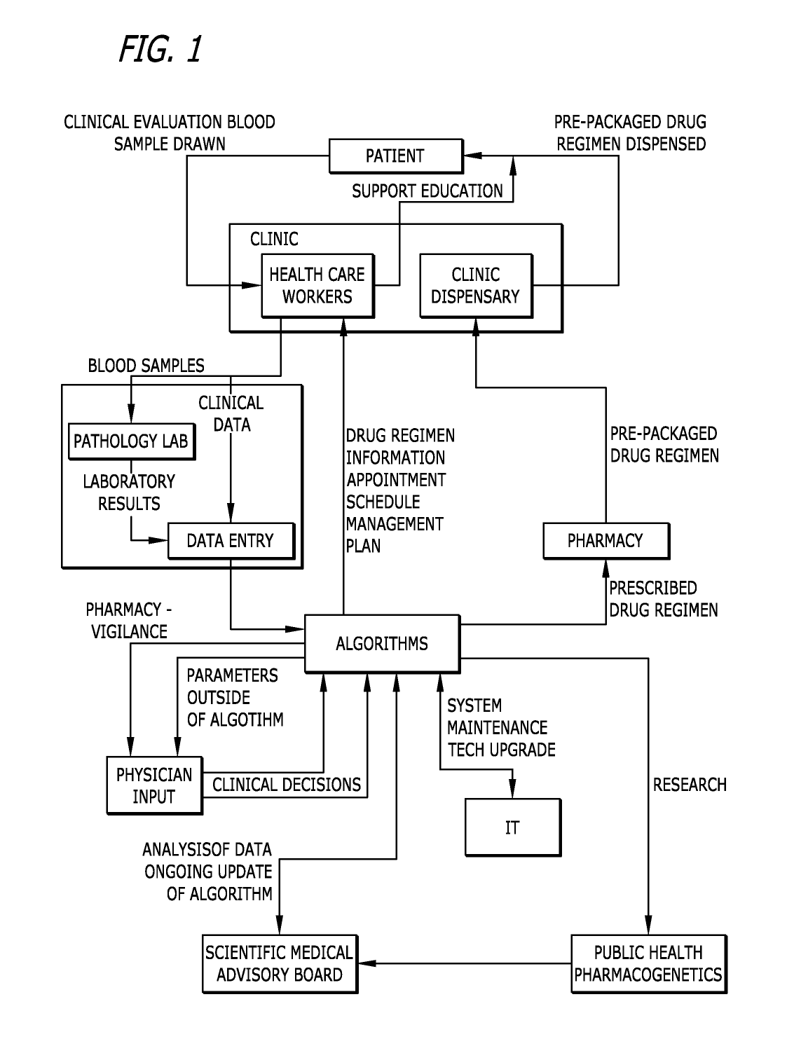

The operating system loop representing one embodiment of the disease management system of the present invention is described in FIG. 1.

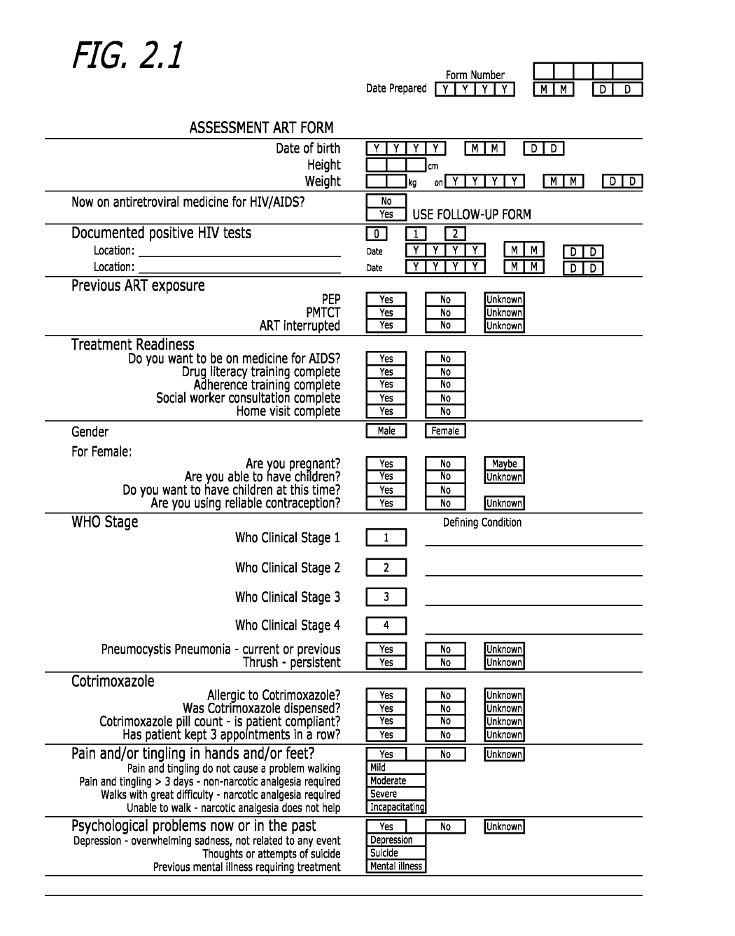

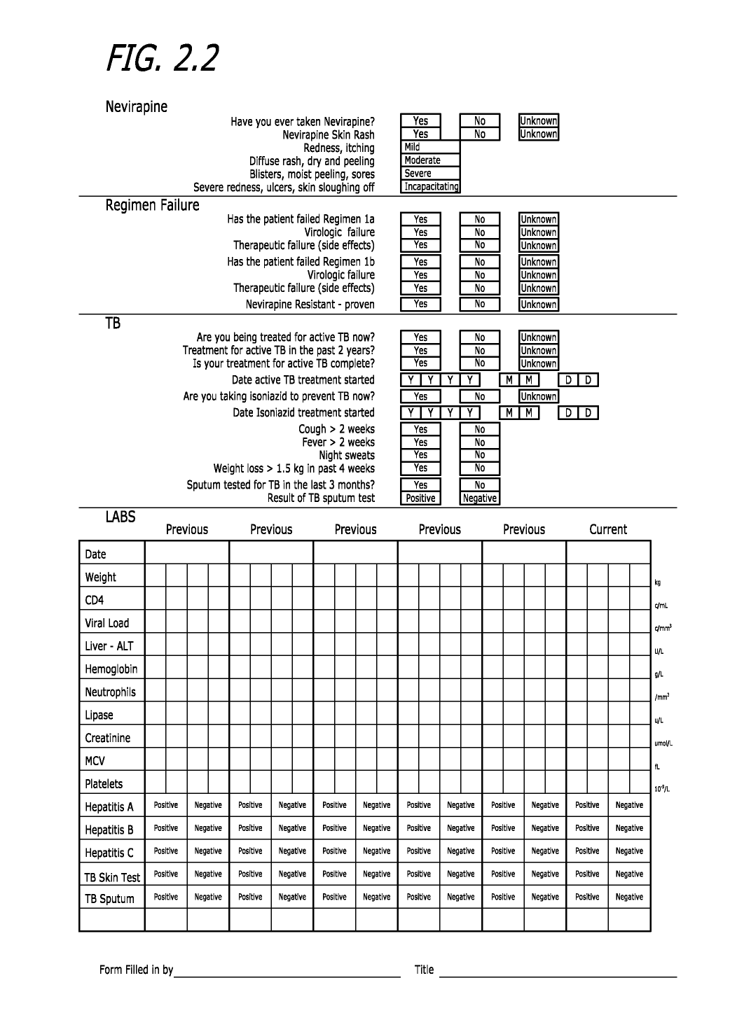

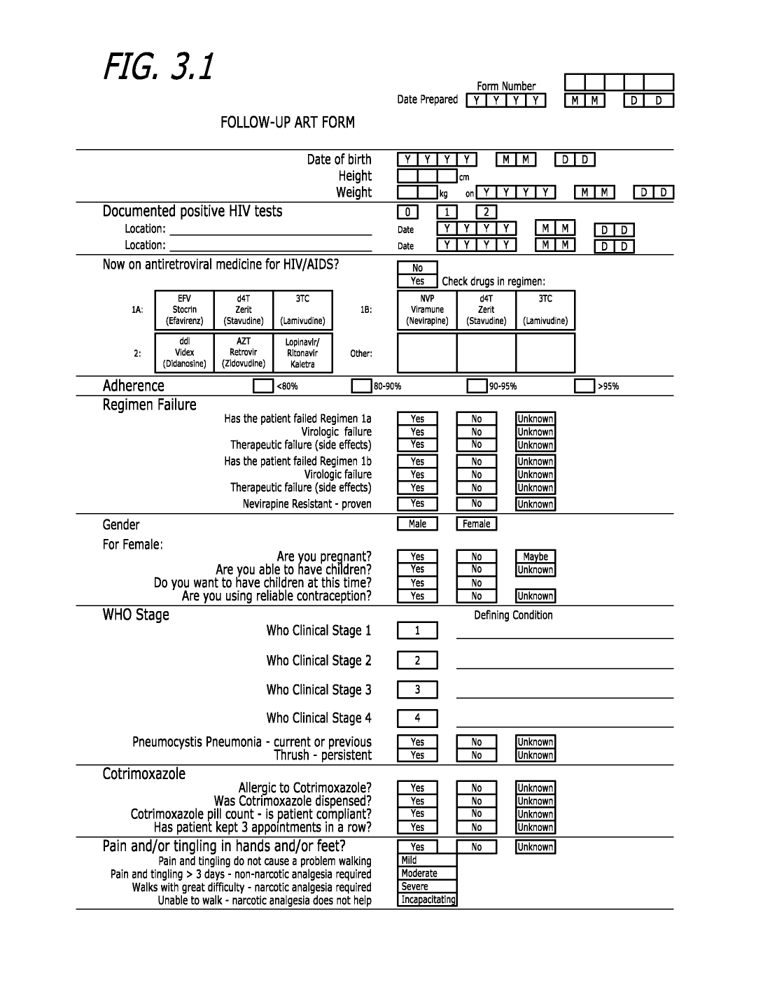

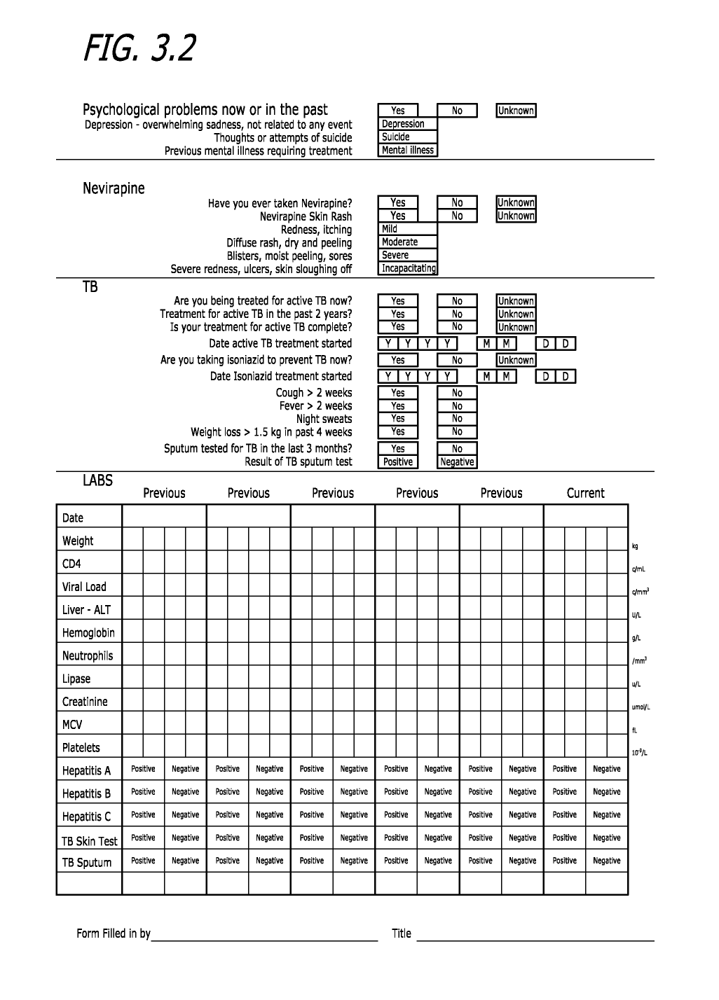

1. Patient interface. An initial visit includes a patient history, a physical examination, and an HIV test. The patient returns to receive an HIV test result. Re-check visits are performed per the protocol and treatment plan. The nurse will contact the call center with the requirements for pick-up of lab sample, or use other technology as appropriate and available. An exemplary patient assessment form can be found in FIG. 2. Additionally, an exemplary follow-up form can be found in FIG. 3.

2. Pathology. Several specialized, centralized labs are served by a transportation network that connects the remotest clinics to the labs within a timeframe compatible with the tests required. The system will be able to optimize and utilize this network for pathology, as well as for data input. In a novel approach, the transportation system will also be used to deliver pre-packaged drugs to the clinic to be dispensed by the nurse. Additionally, in areas where lack of telephone or wireless services prevent data entry and transmission directly into a computerized database, paper forms can be sent to the pathology lab along with samples to be entered into the disease management system by lab personnel.

3. Opportunistic infections will be treated.

4. HIV Treatment. The algorithm of the present invention will be applied to the patient data, with several possible outcomes:
a. Patient's immune system is not compromised enough to require HAART. Patient receives education on the natural history of the disease, nutrition and preventing transmission of HIV. Depending on their nutritional status, supplemental vitamins, minerals, and protein will be dispensed by the system. A novel feature of the system lies in its ability to begin to empower the patient to be compliant with a regular regimen of pills/supplements and follow-up appointments, to have them benefit from support groups, and to keep them within the system of the present invention so that they receive social and emotional support, and antiretroviral therapy as soon as they require it. These patients will be reevaluated according to the intervals outlined in the protocol. An exemplary, non-limiting example is re-evaluation every three months.
b. Patient is severely immune compromised and acutely ill with a severe or life-threatening opportunistic infection. Patient is referred to a hospital or tertiary center, and enters the system of the present invention on their discharge to their community.
c. Patient's immune system is compromised enough to require HAART, but they fall within the extremes of the parameters of the system algorithm of the present invention, or they present with unusual signs and symptoms. The algorithm would refer all cases at the borders of the parameters to be reviewed by a physician, who would enter orders into the system of the present invention. Through this mechanism, the parameters of the system of the present invention would widen to include more variables over time.
d. Patient's immune system is compromised enough to require HAART, and they fit comfortably within the parameters of the system algorithm of the present invention. Patient receives psychosocial support, education on nutrition and preventing transmission of HIV. Depending on their nutritional status, supplemental vitamins, minerals, and protein are dispensed. Patient is educated in the benefits and possible toxicities of HAART, as well as the importance of compliance. HAART and prophylaxis against opportunistic infections are dispensed per protocol.
e. The treatment protocol modified by the system algorithm of the present invention for infants, children, women of child-bearing potential, pregnant and breastfeeding women.
f. In all the above, the system of the present invention would incorporate evaluation of associated diseases such as tuberculosis and malaria, as needed in the local area.

5. Prescriptions. Concurrently, the algorithm of the present invention initiates dispensing of HAART drugs appropriate to the patient, and the medications are delivered to the clinic by the transportation system that serves the pathology labs. Prescriptions are pre-packaged and labeled confidentially, by means including, but not limited to, bar coding, for the individual patient, and include culture and education-appropriate instructions. Inherent in the system algorithm of the present invention are checks for drug interactions and allergies.

6. Statistical Output. The system algorithm of the present invention interprets trends both for an individual patient, and within the database as a whole. In a non-limiting example, this allows for detection of conditions such as resistance of HIV to 1^{st} line HAART in an individual or increased incidence of toxicity to a certain drug within an entire area. The co-occurrence of other diseases and the impact of multiple medicine regimes would also be assessed.

Information from cases outside of the parameters of the system algorithm will be considered as the algorithm is constantly updated, so that the parameters of the algorithm become wider and wider. Patient data remains within system, even when they are referred to a different hospital.

7. Communication of data and treatment plans back to healthcare worker. There will be communication back to the healthcare worker regarding the patient's status, lab results and treatment/care plan as reflected in the database and interpreted by the algorithm of the present invention. Communication can be in the form of SMS, or hard copies of reports delivered with the medication. Batch reporting can include such information such as upcoming visits, and those patients who missed appointments and require intervention.

This feedback of processed information to healthcare workers can be used to empower them by increasing their level of knowledge about the management of HIV and associated diseases, and supporting them in the care of these patients.

8. Patient re-evaluation per protocol. Patients will be re-evaluated according to the protocol and algorithm of the present invention. For example, when beginning HAART, patients will be recalled within a shorter duration than those who have proven their compliance and tolerance for the drugs over a period of time. If testing reveals a patient is non-compliant, the patient would be placed on a shorter interval between scheduled tests.

At each step of the operating system loop, patient data can be accessed remotely by healthcare workers at any site where the patient is seeking medical attention. This feature allows the successful management of nomadic patients or in instances when patients require treatment or follow-up away from their home provider.

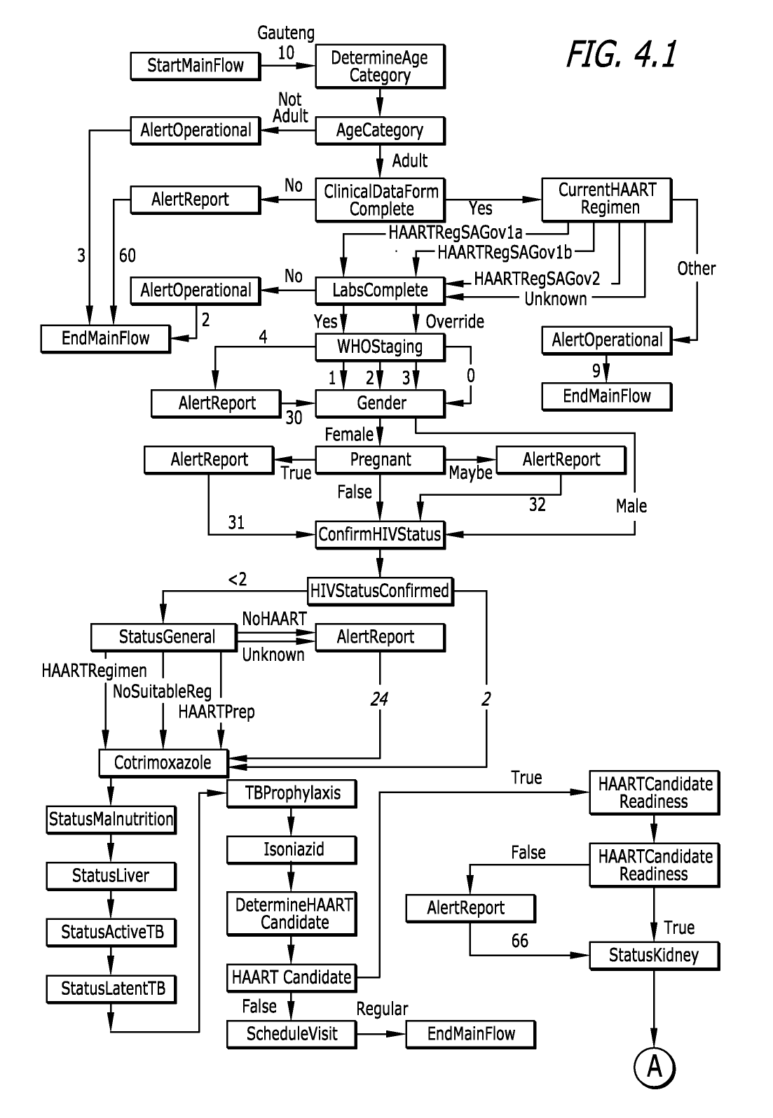

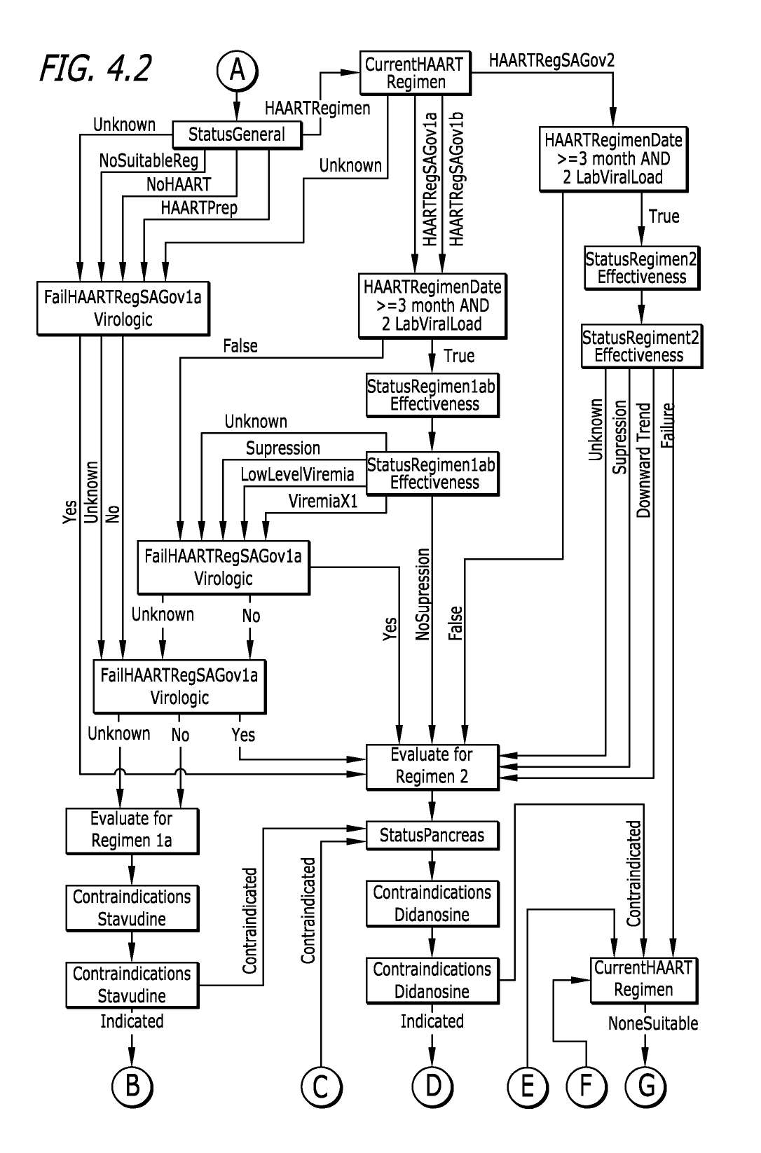

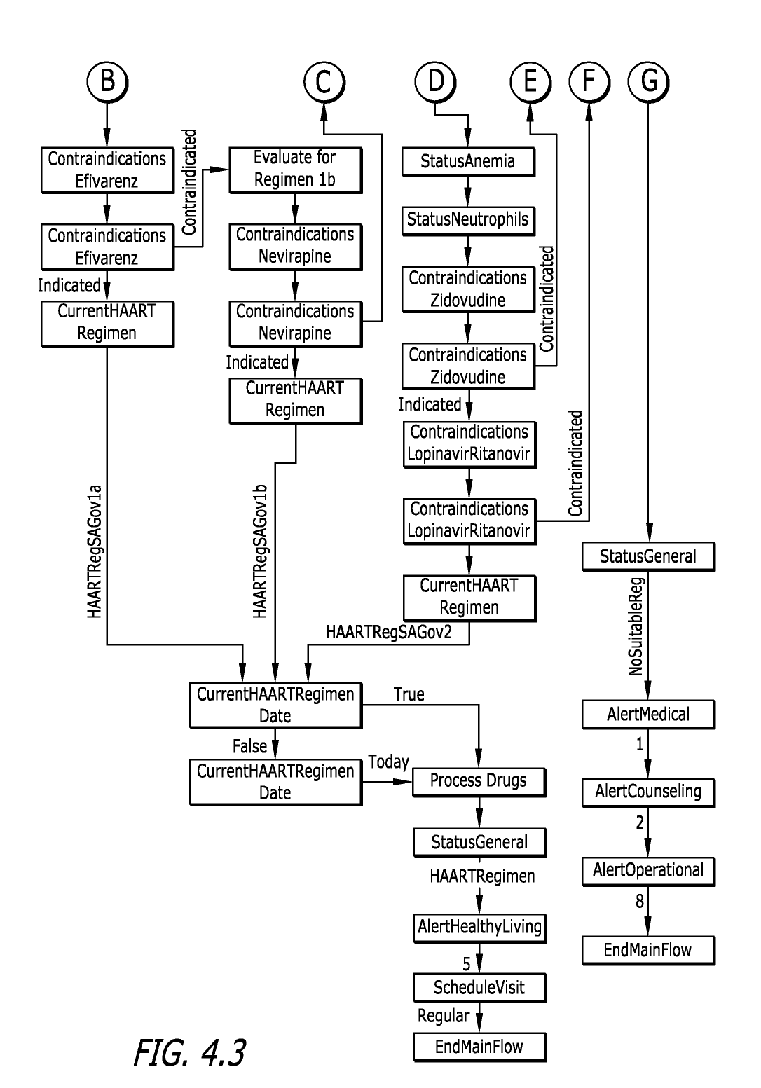

An exemplary, non-limiting algorithm useful in an embodiment of the invention is depicted in the flow chart diagram of FIG. 4. (Note that FIGS. 4.1, 4.2 and 4.3 are part of the same flow chart.)

The exemplary algorithm of FIG. 4 presents a disease management system for HIV/AIDS. It would be reasonable to one skilled in the art to use this algorithm in the treatment of other diseases besides HIV/AIDS. Therefore the use of HIV/AIDS in the algorithm of the present invention is for exemplary purposes only and the present invention is intended to be used for the treatment of a wide range of diseases including, but not limited to, tuberculosis, cancer and other infectious diseases.

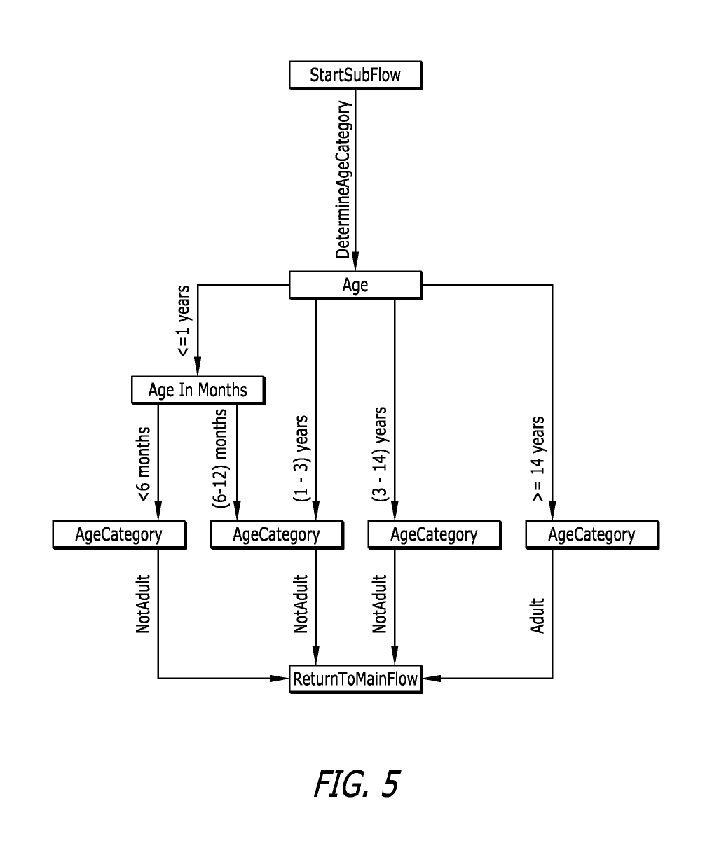

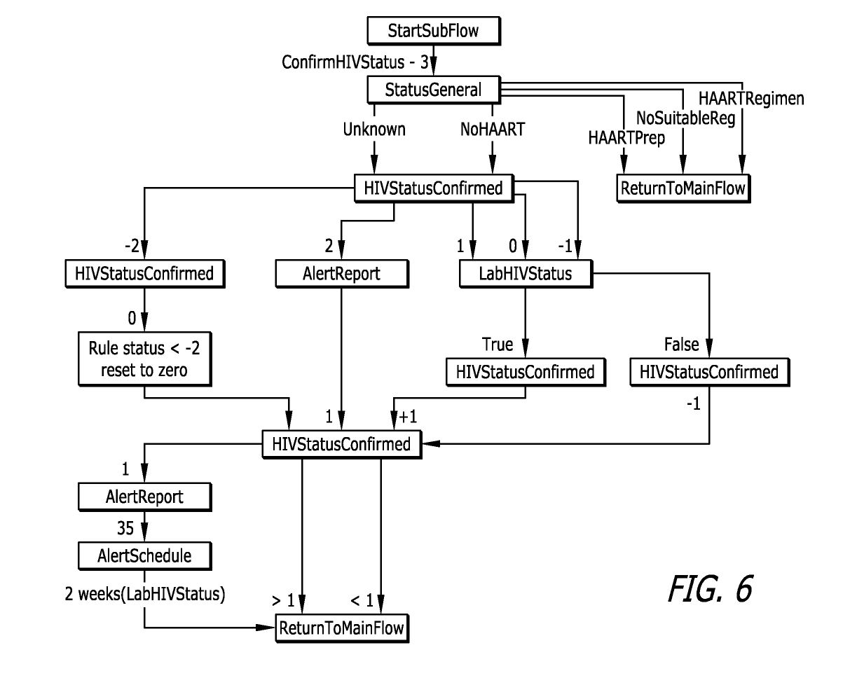

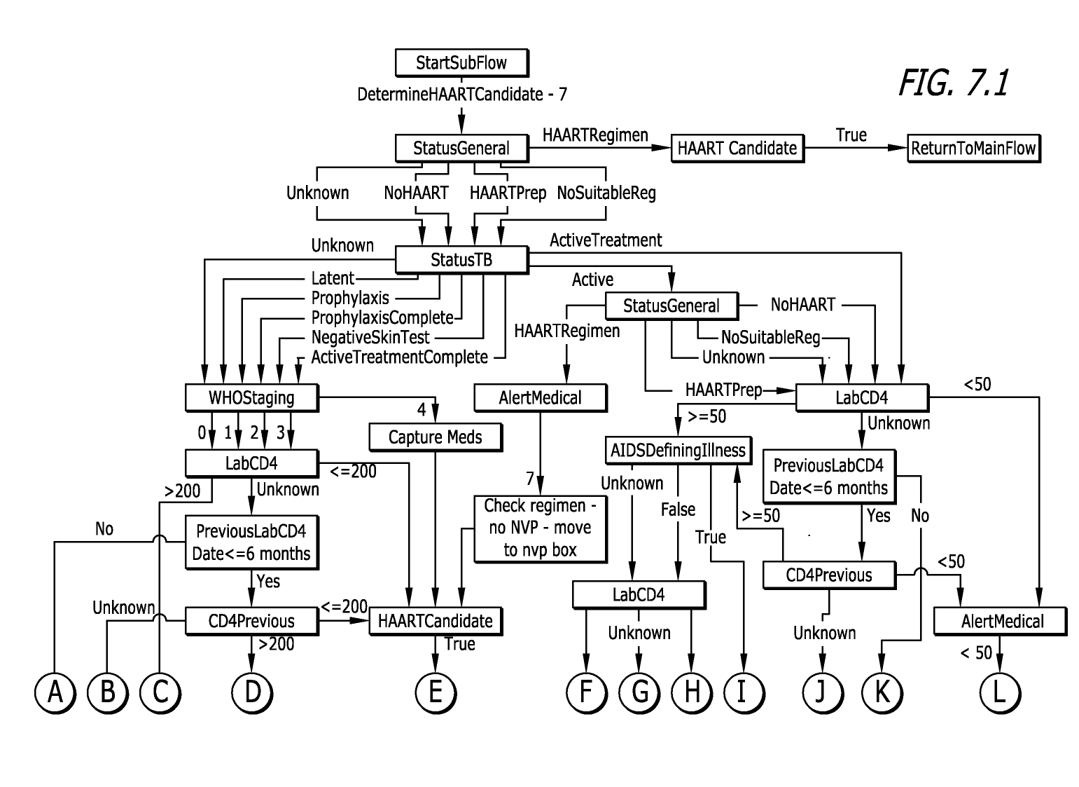

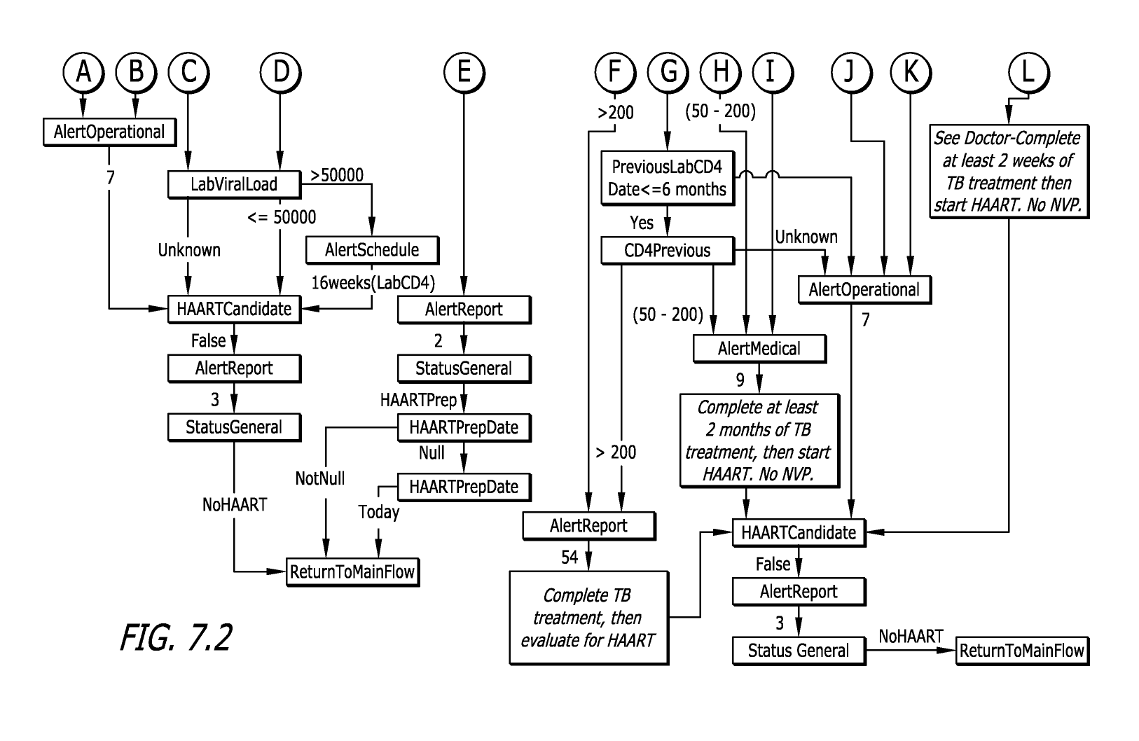

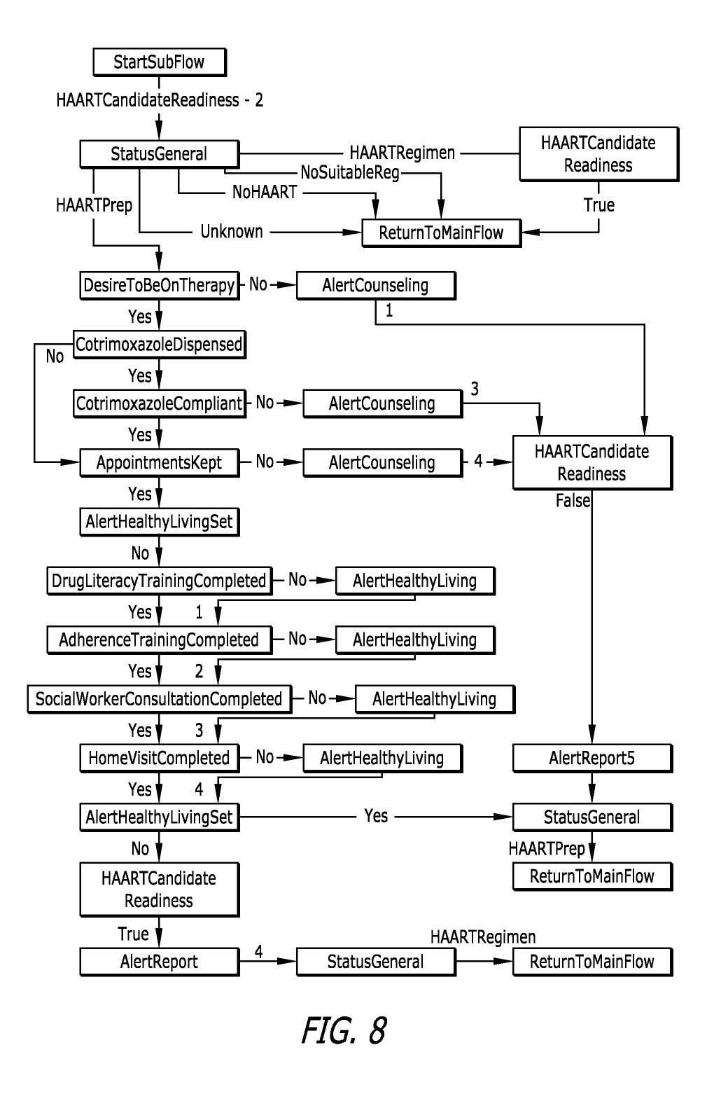

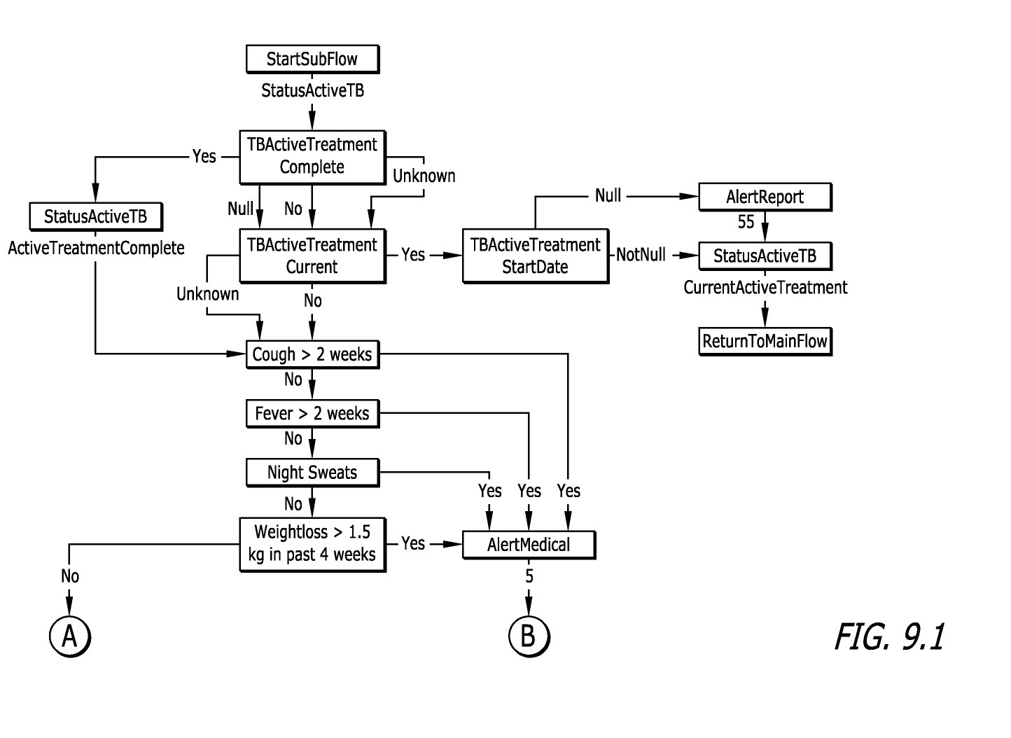

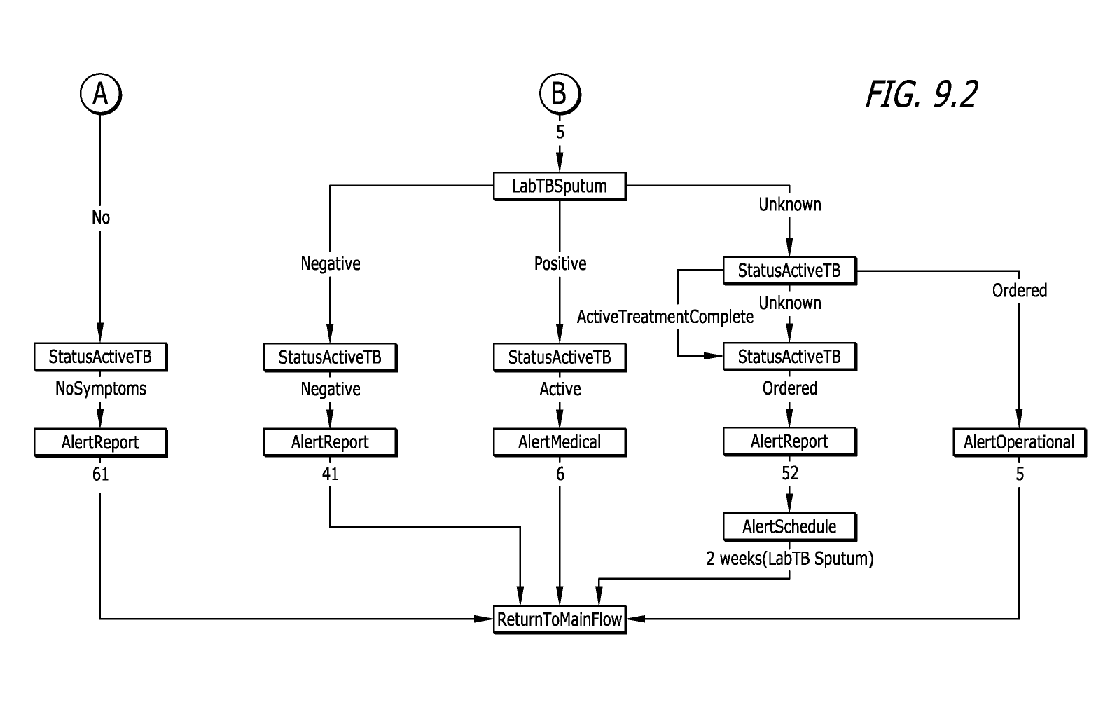

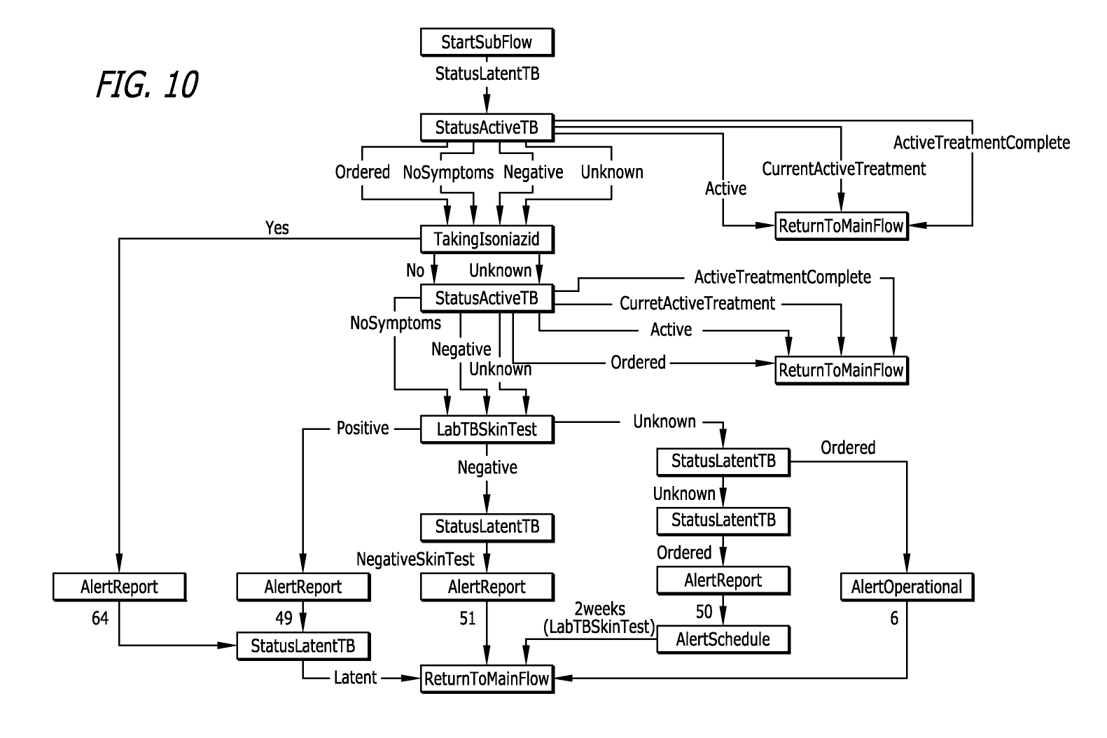

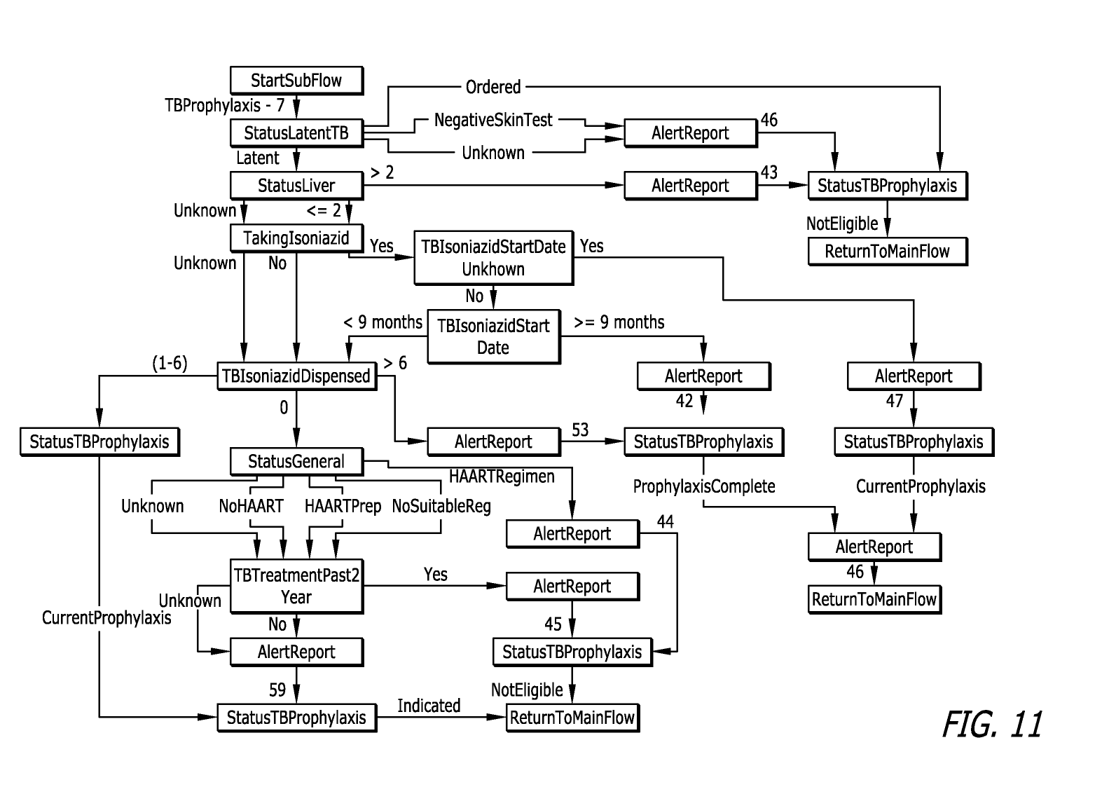

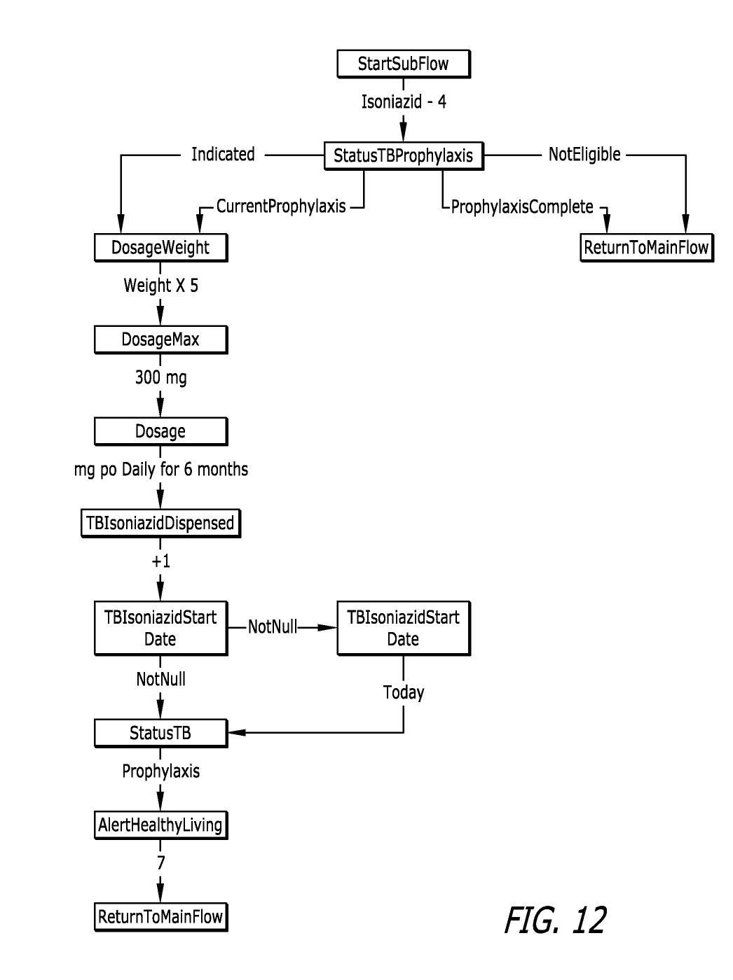

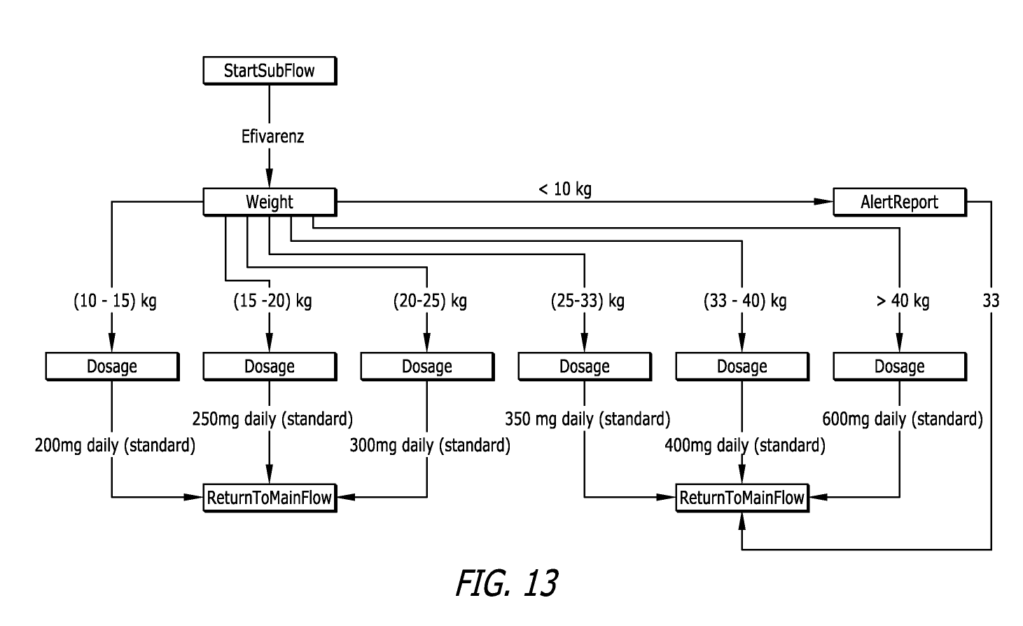

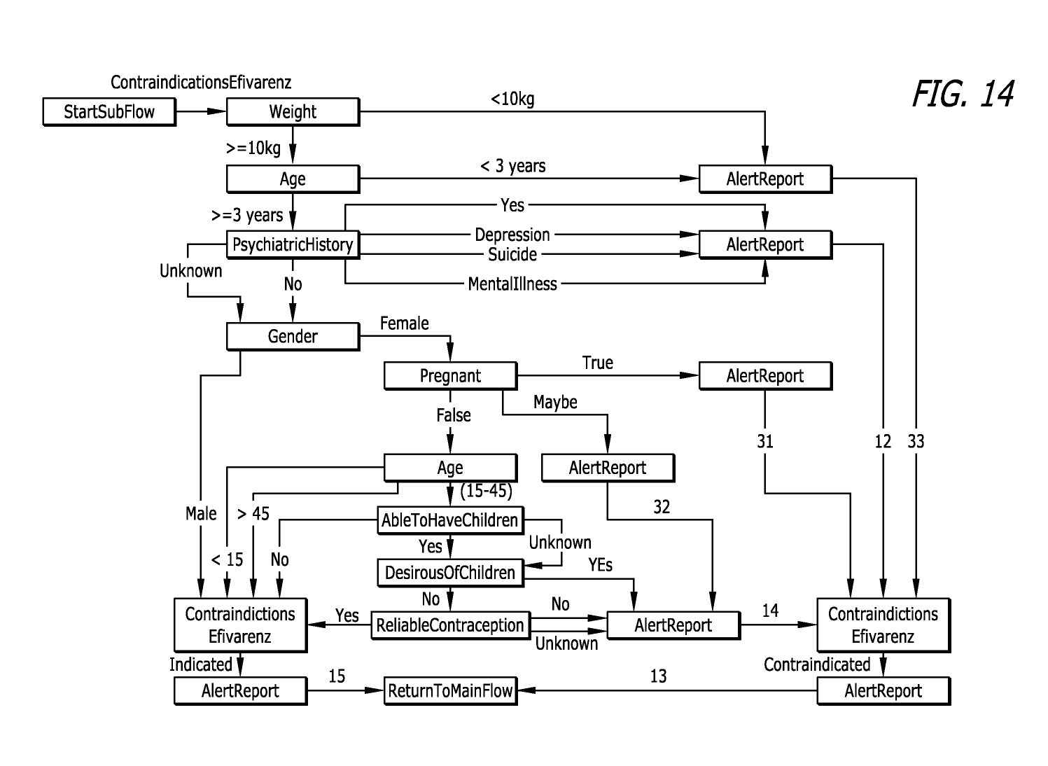

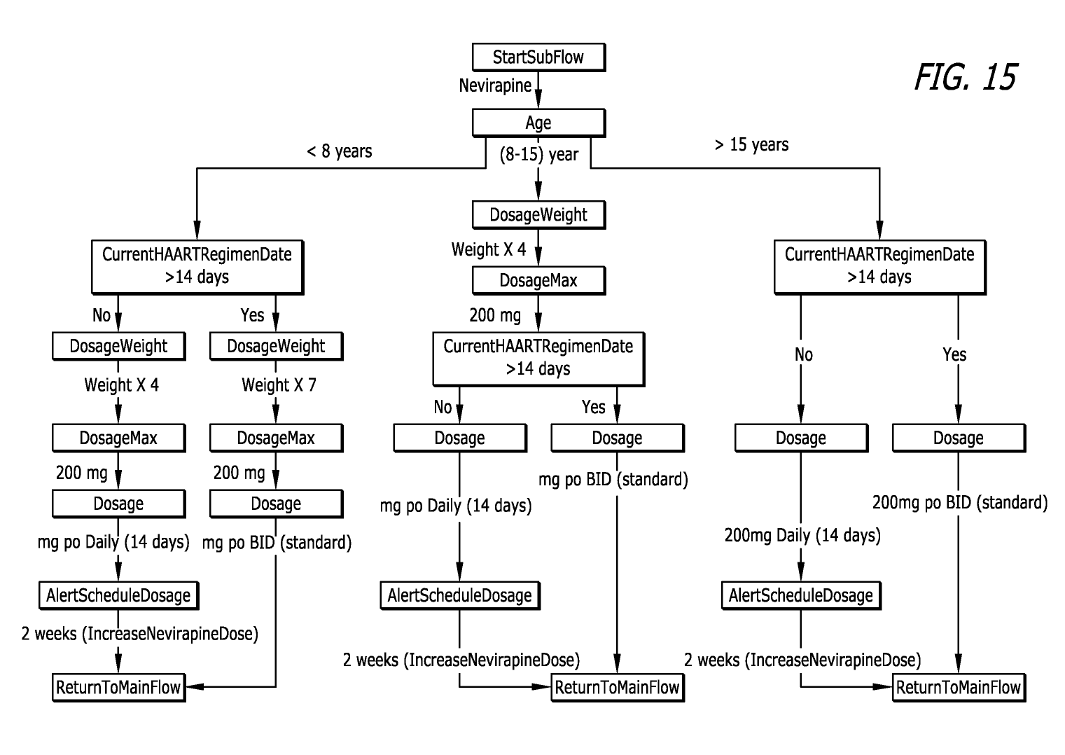

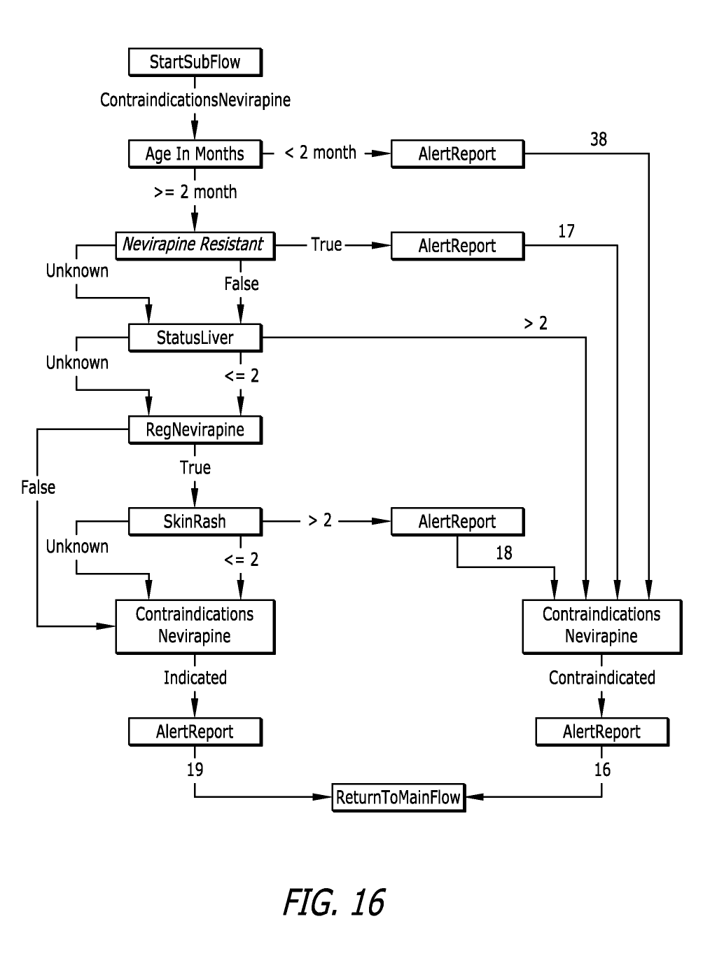

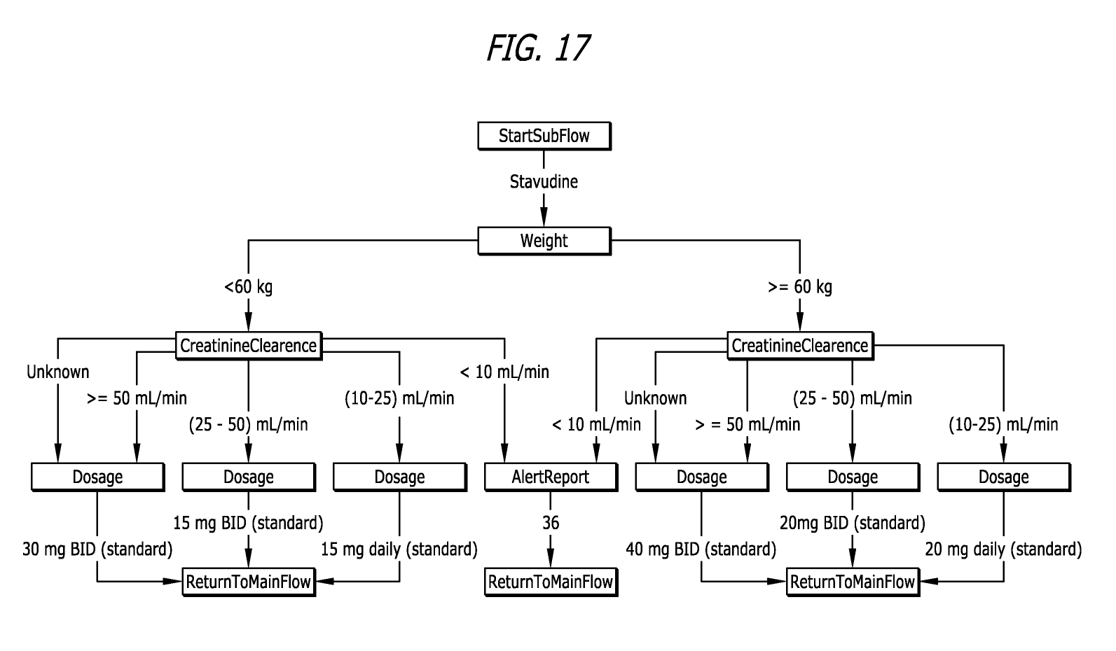

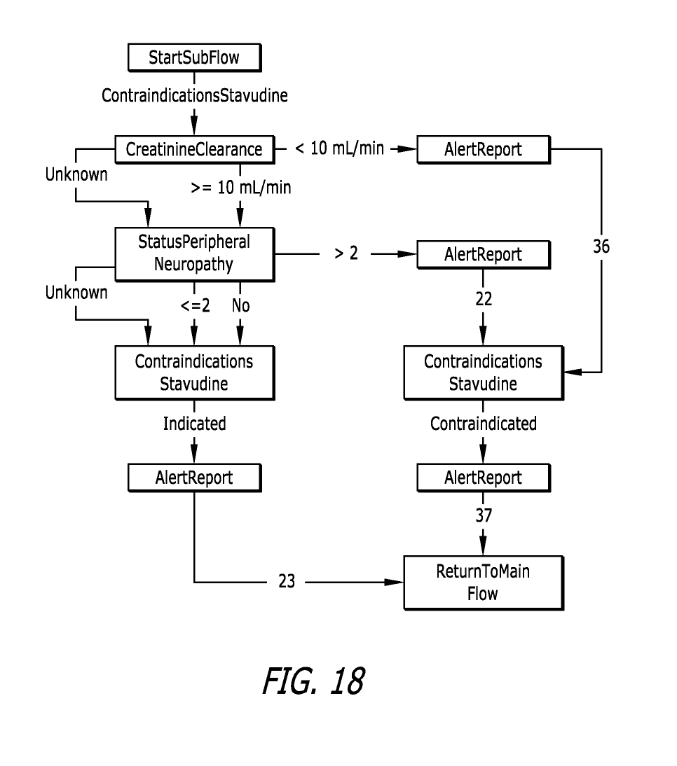

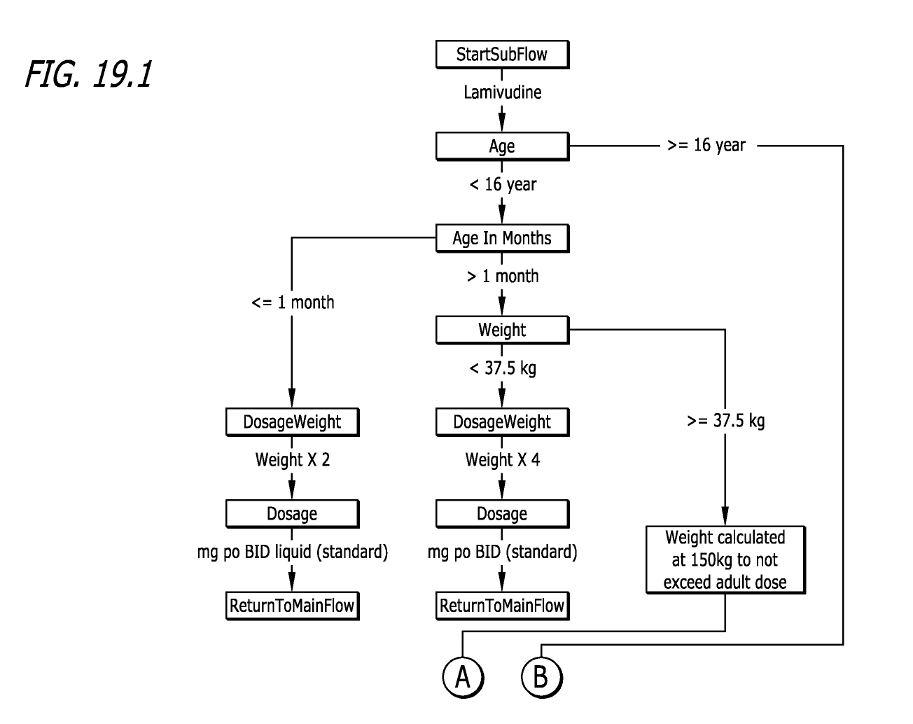

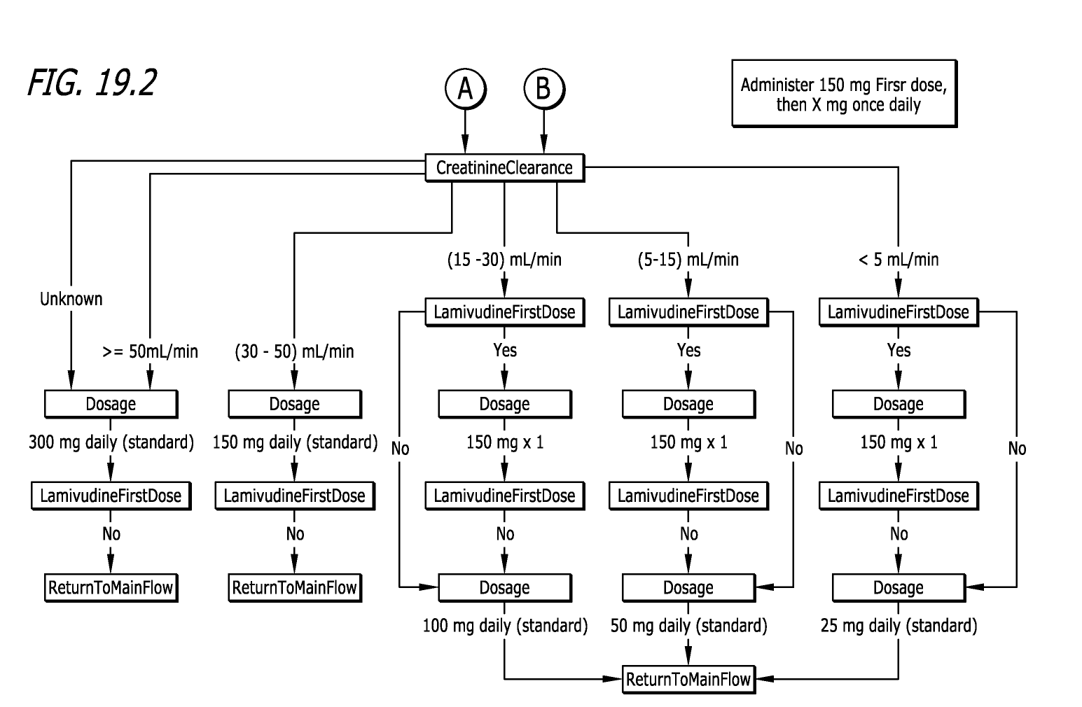

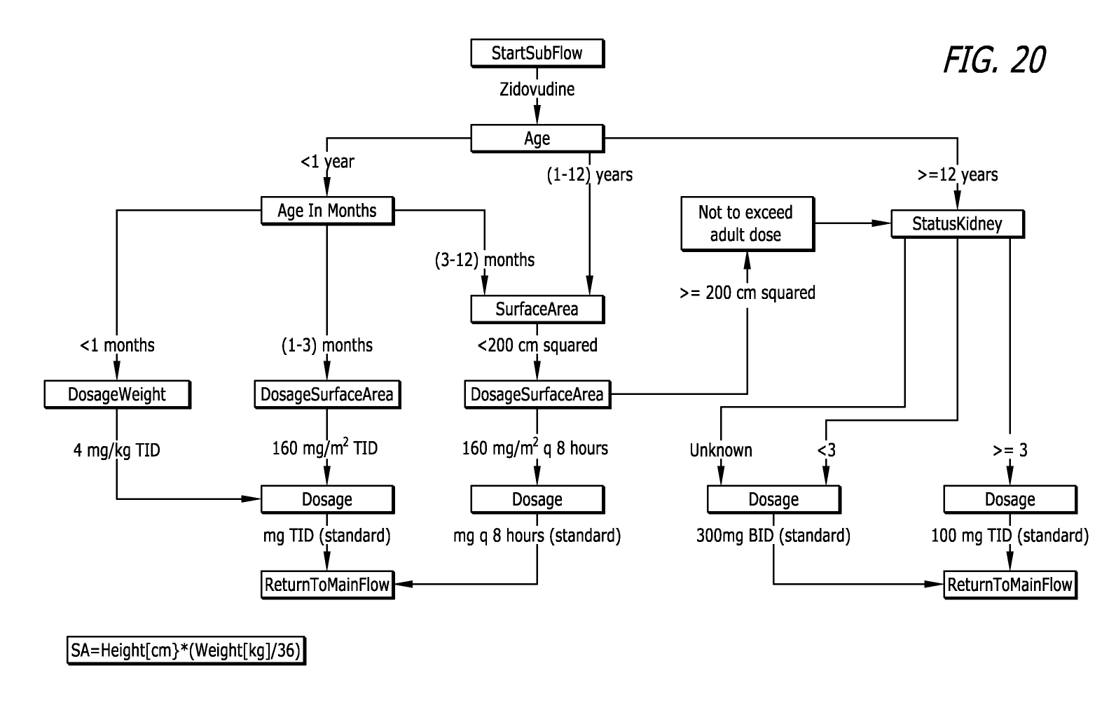

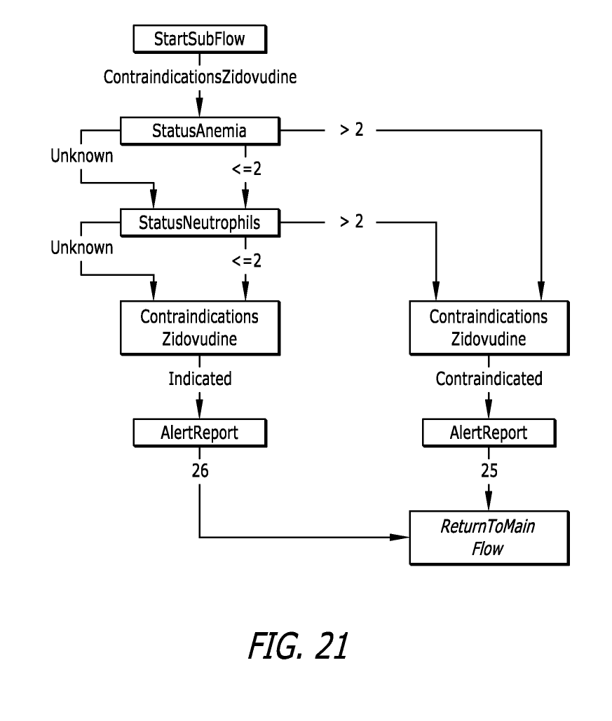

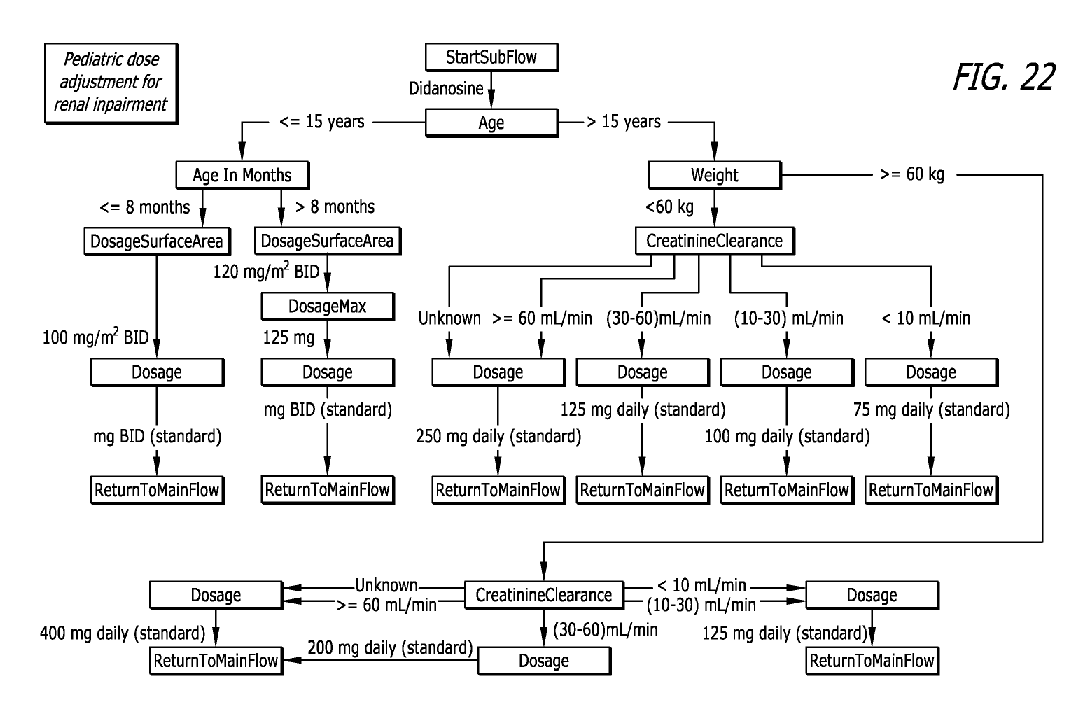

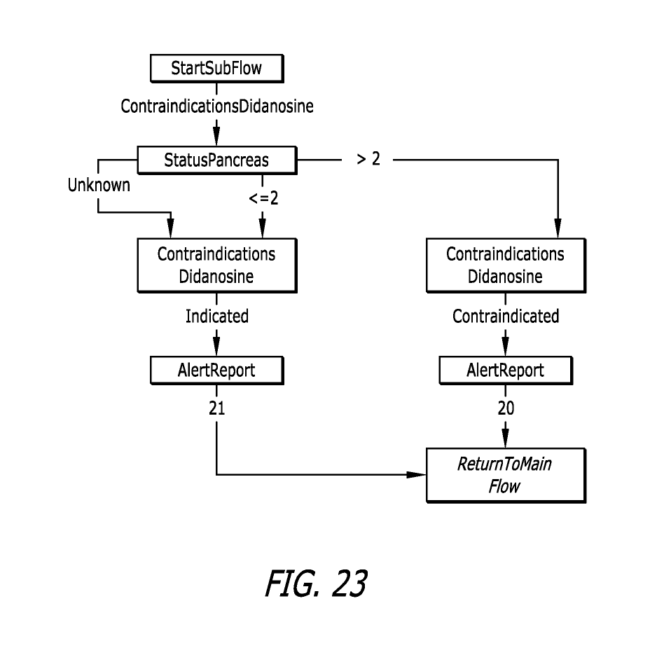

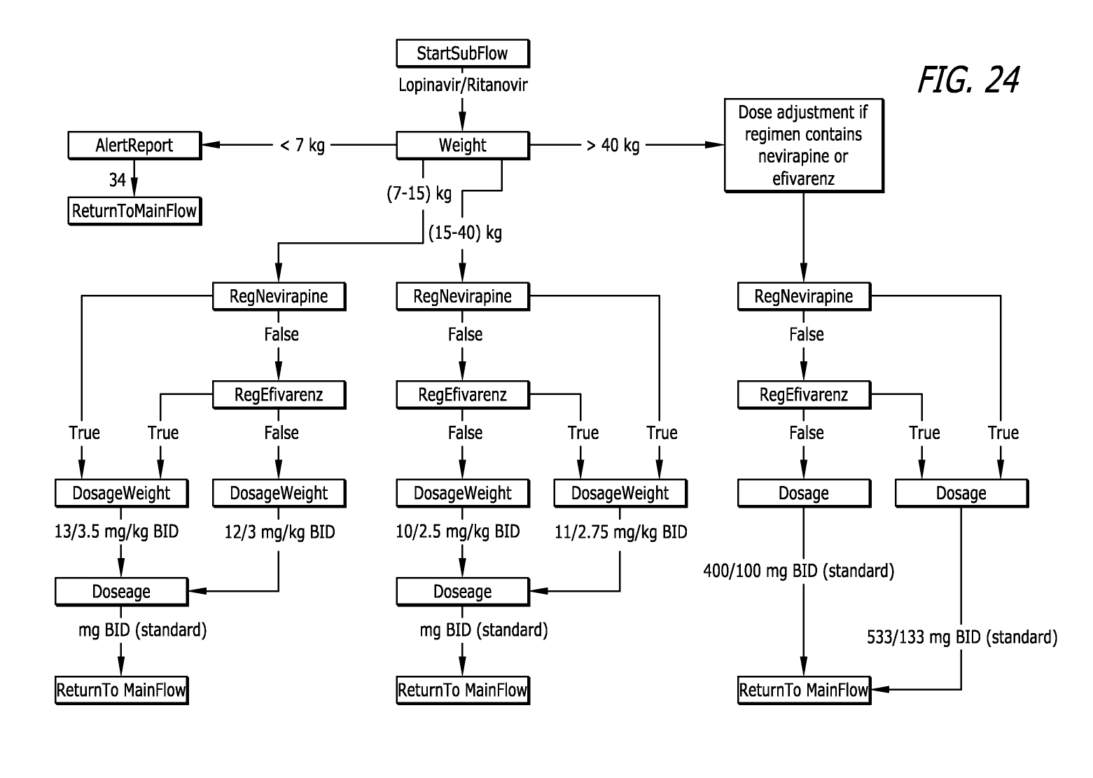

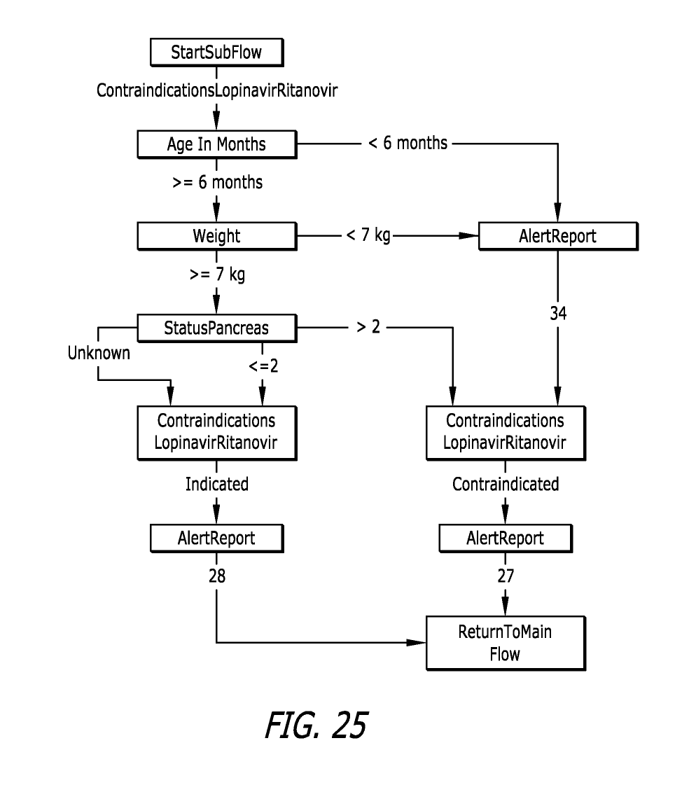

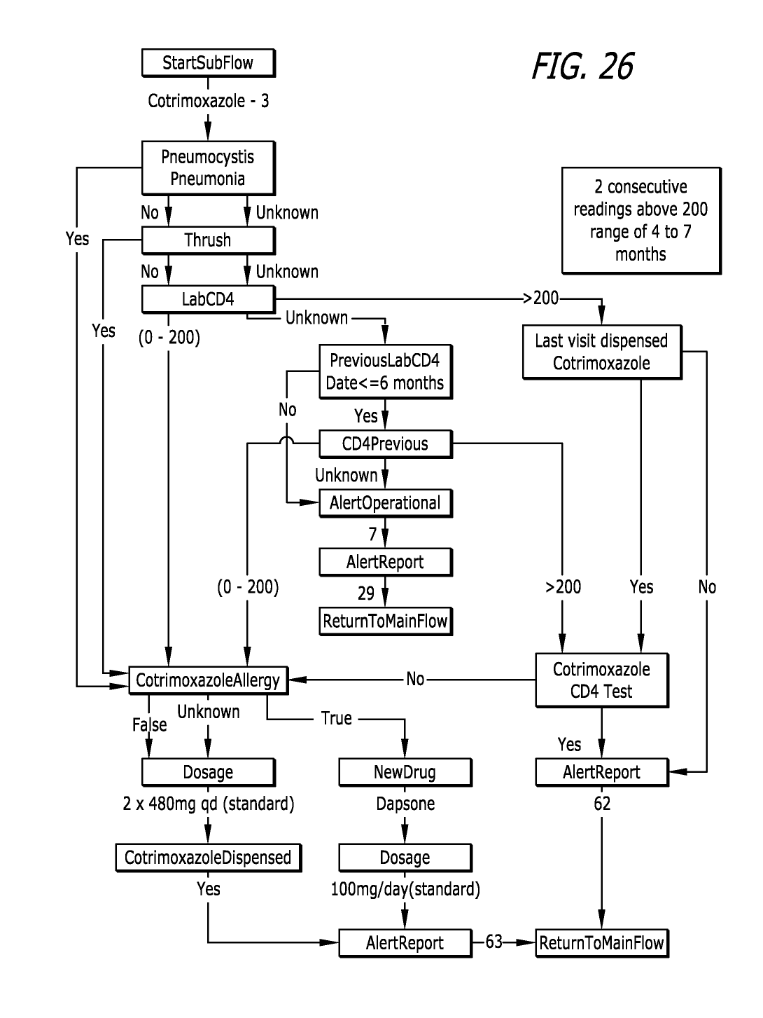

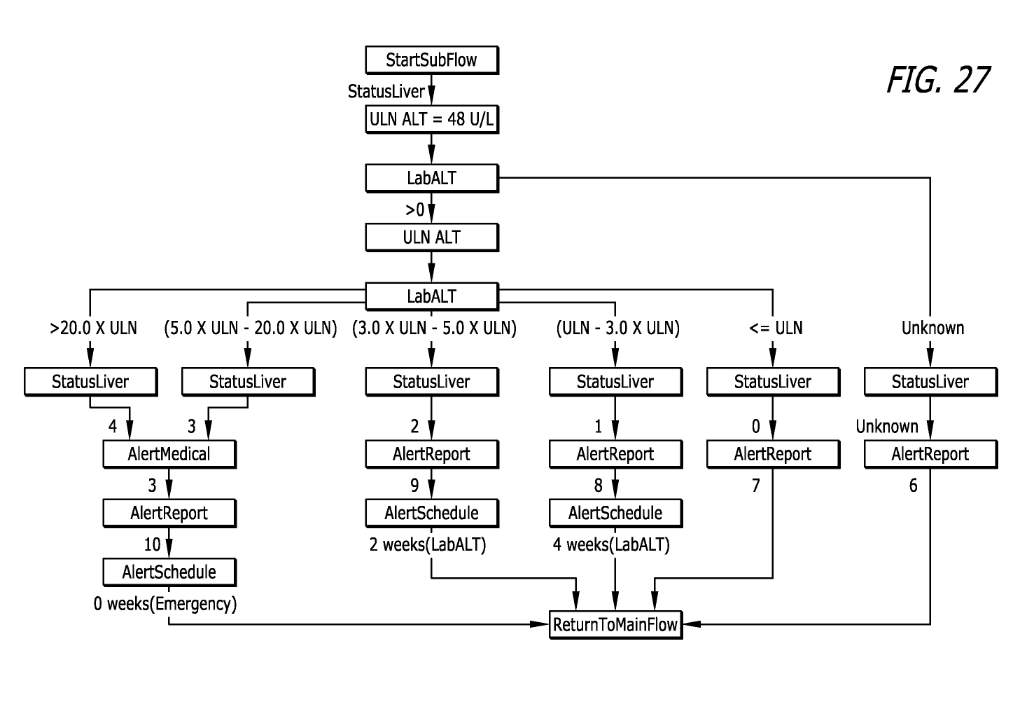

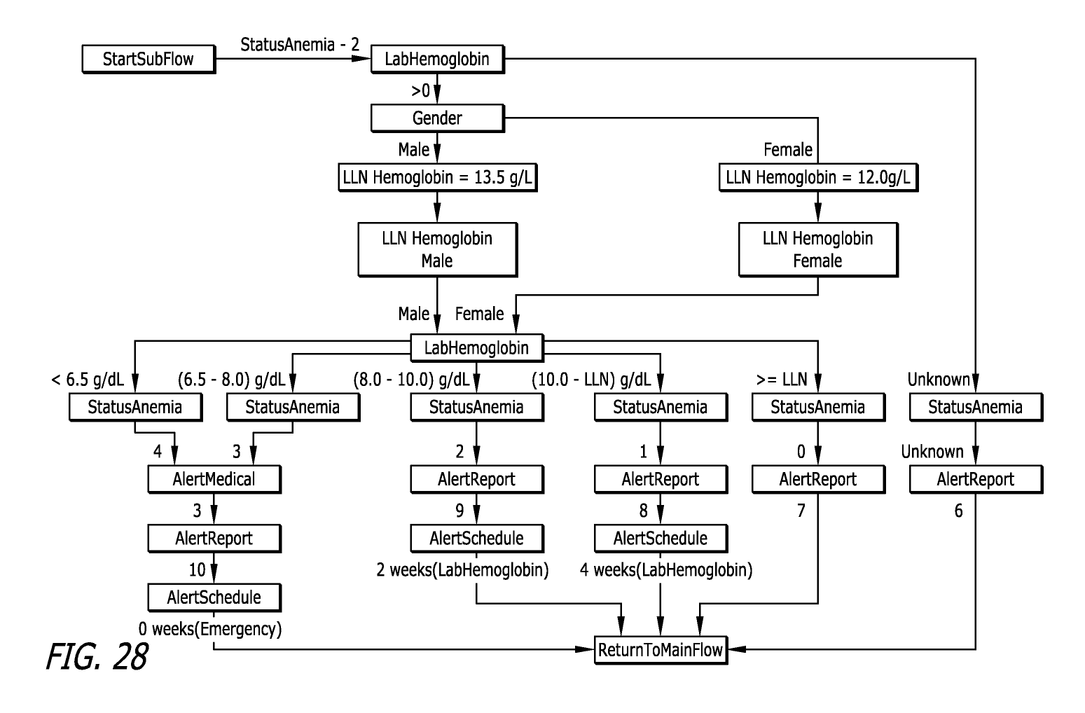

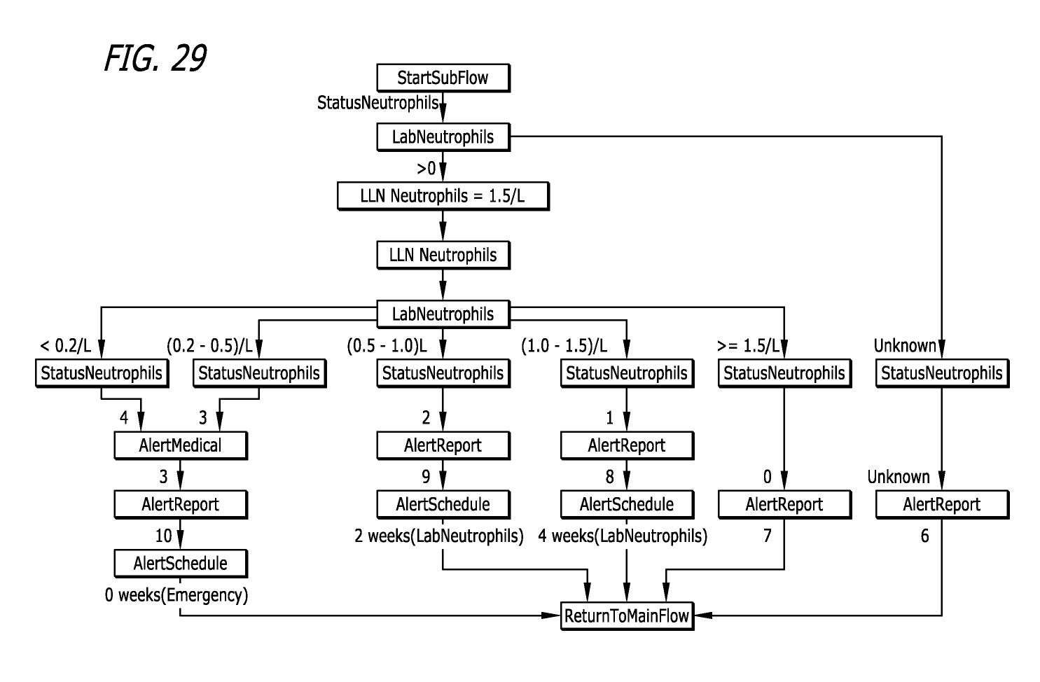

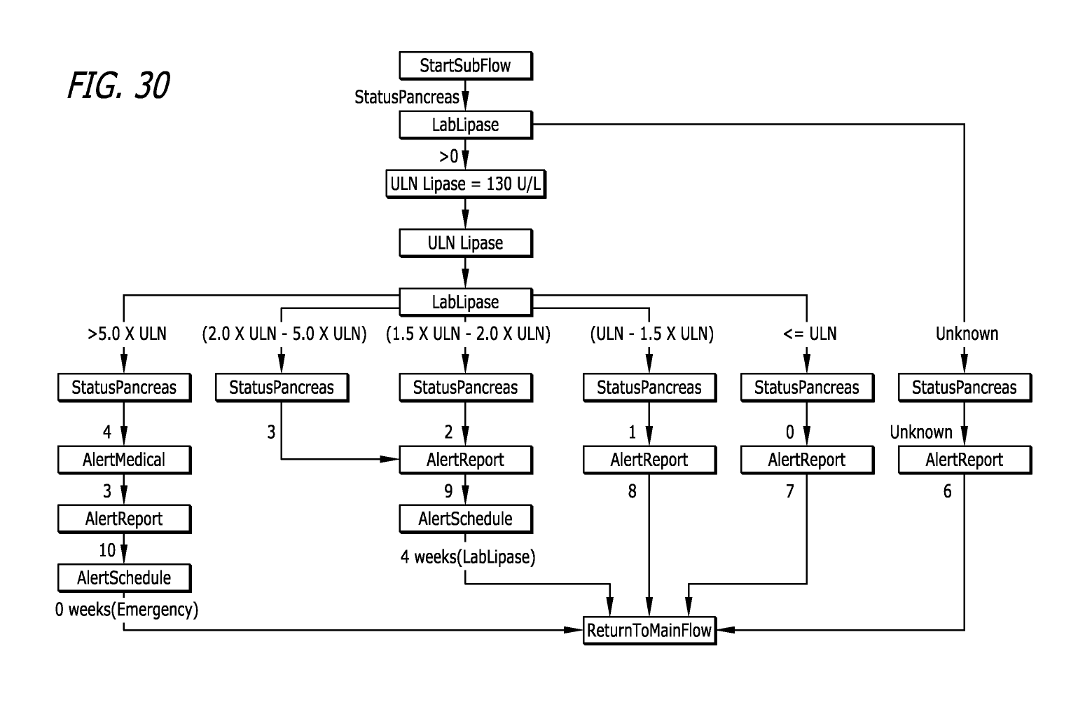

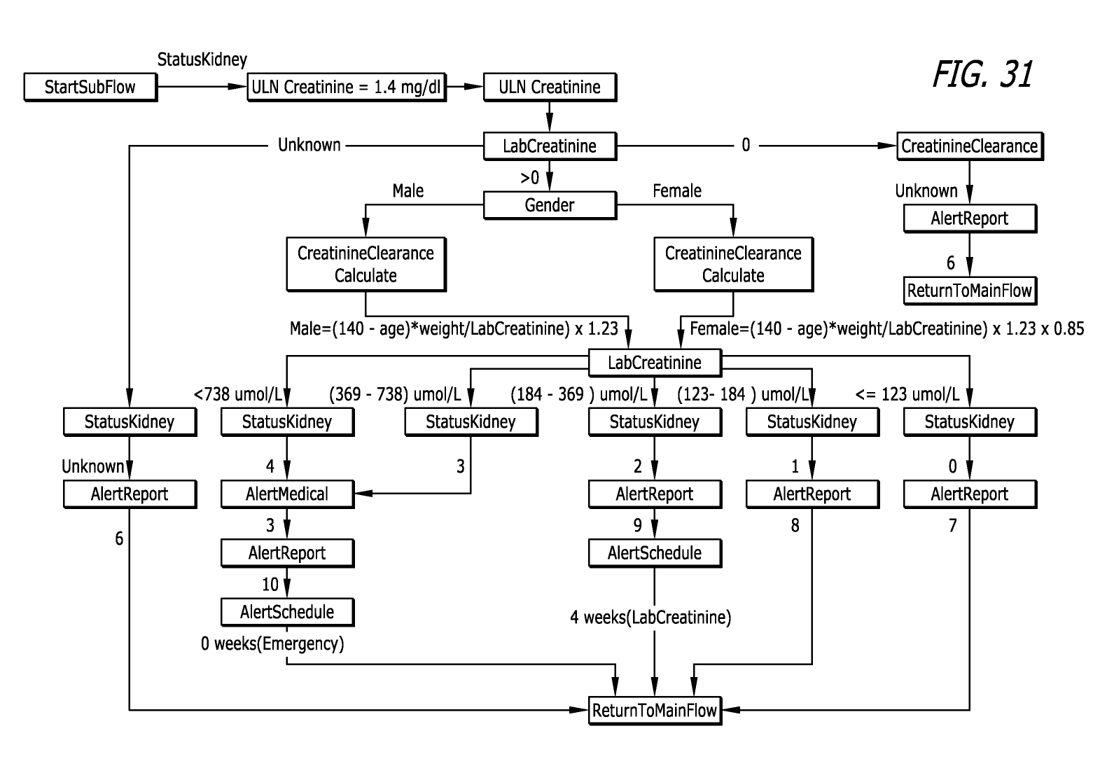

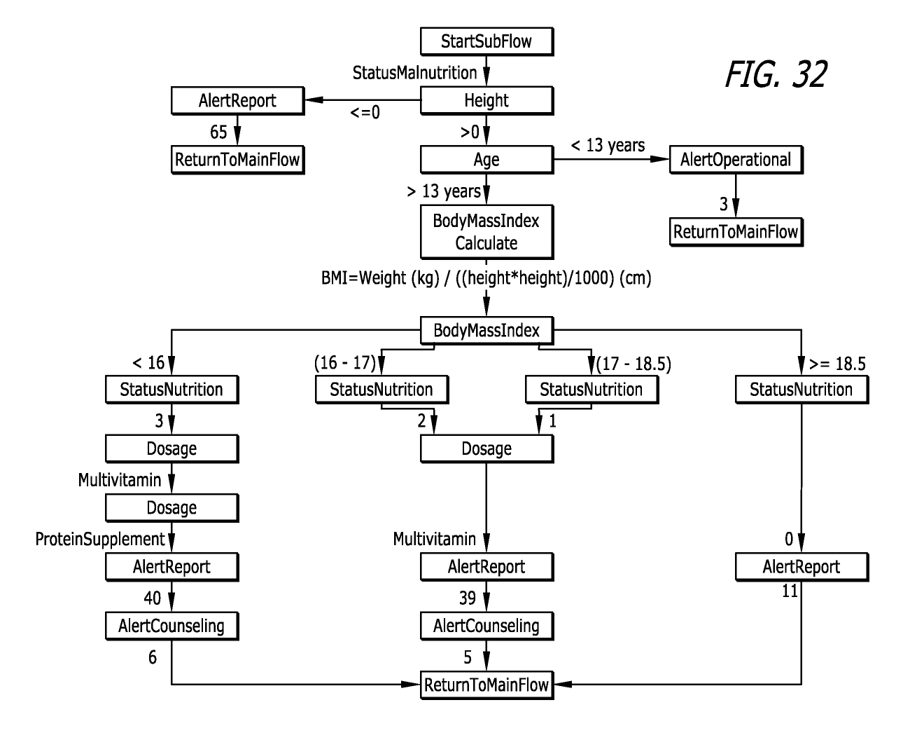

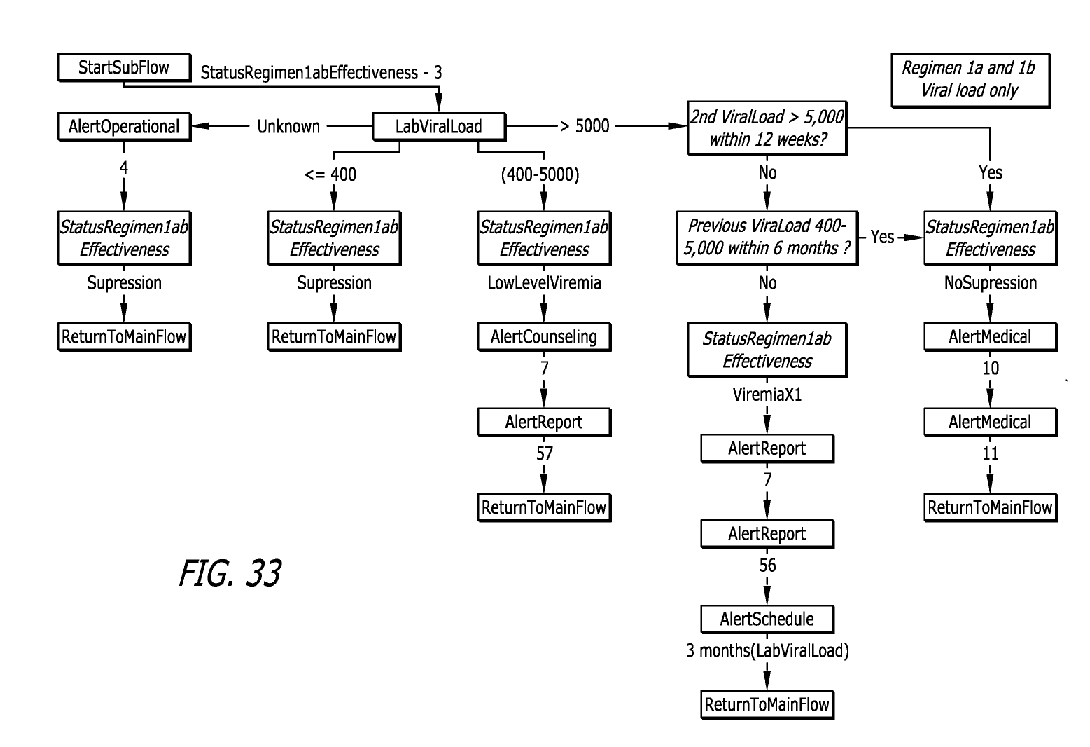

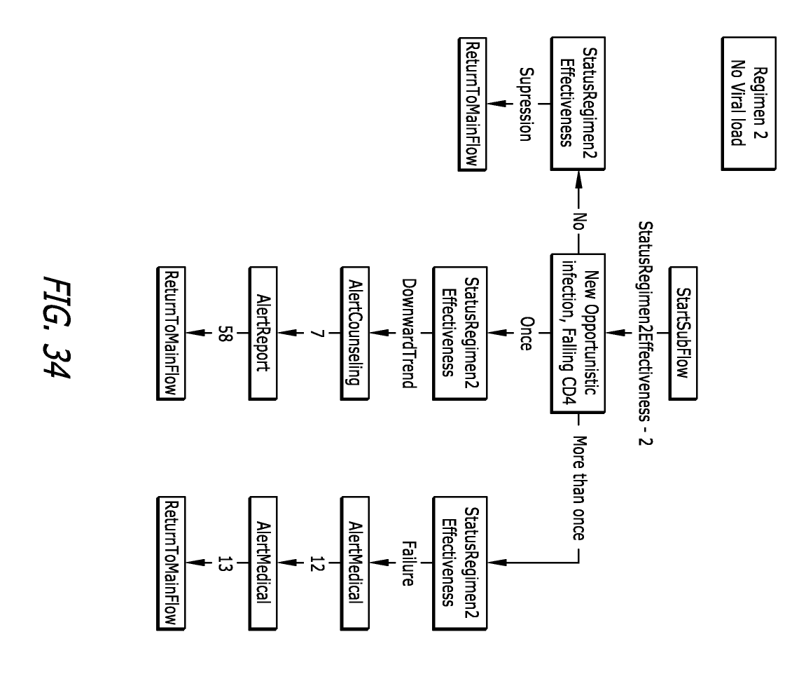

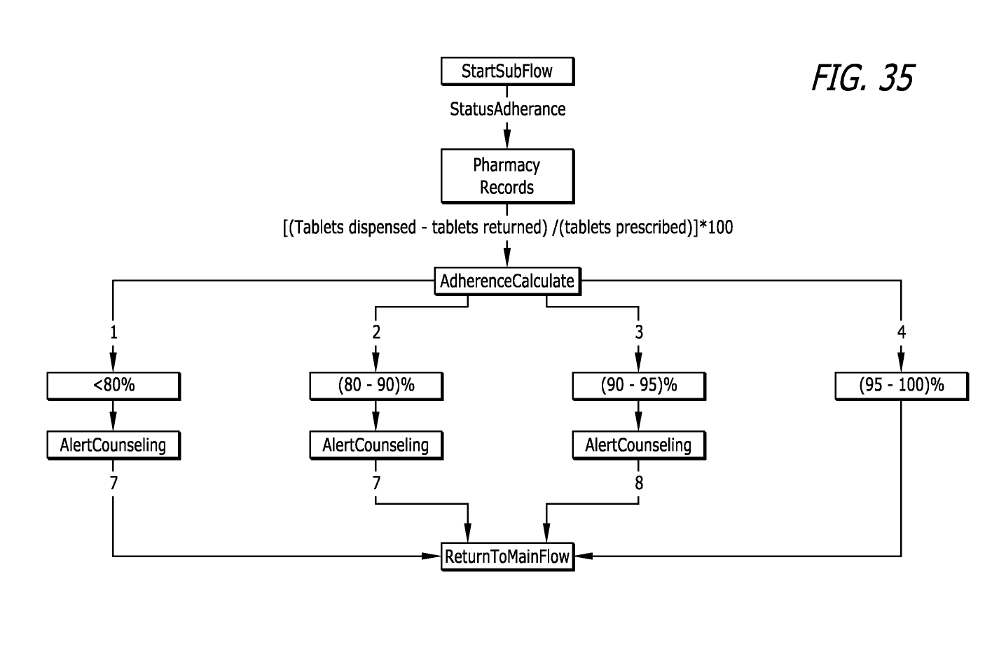

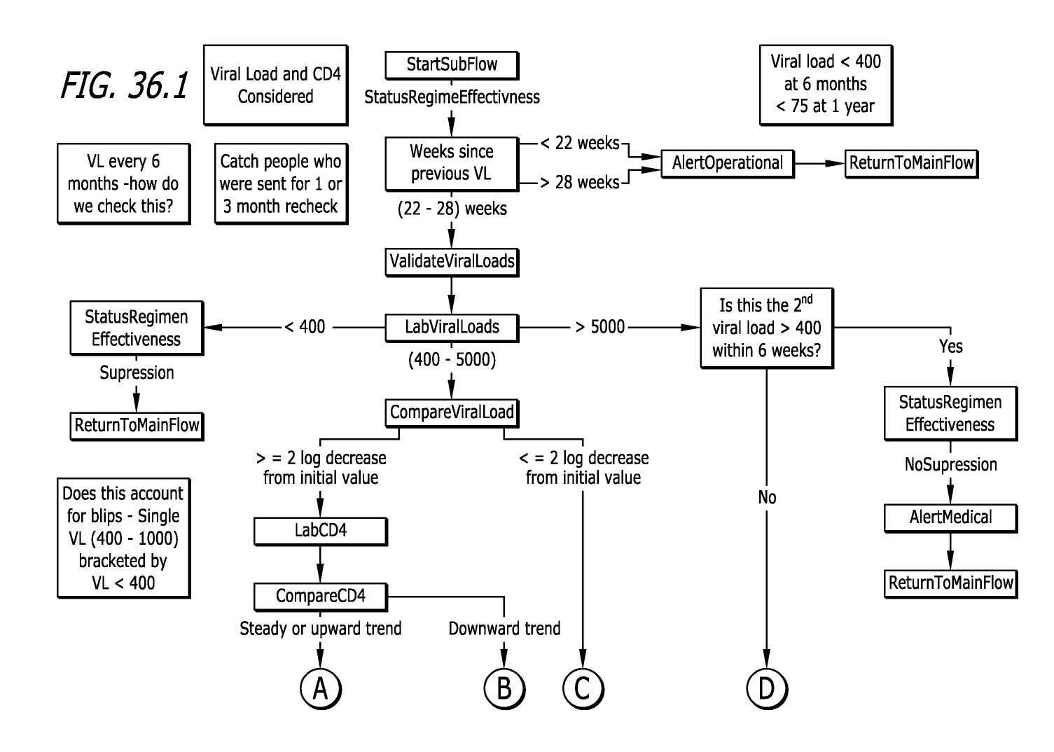

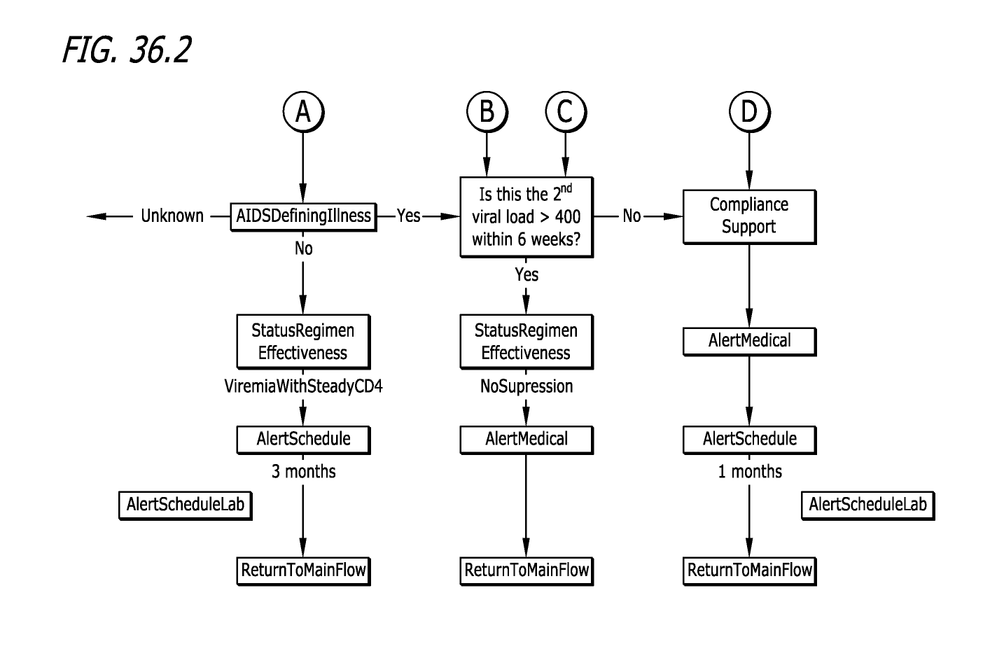

FIGS. 5-36 represent exemplary sub-algorithms (flows) triggered from the main algorithm depicted in FIG. 4. Flow of data through these sub-algorithms provide a comprehensive disease management plan to the primary healthcare worker and therefore to the patient and additionally provide pharmacovigilance and demographic information to regional and national health agencies. The exemplary algorithms of the present invention generate a series of alerts to query the healthcare worker, laboratory personnel or database manager under certain conditions. Alerts are classified as counseling alerts, healthy living alerts, medical alerts, operational alerts, reporting alerts and scheduling alerts. Alert priorities divide alerts into those which require an action (1), those that alert to a parameter outside of normal (5) and those that inform of a parameter within normal limits (9). Table 1 contains a list of alerts referenced in the exemplary algorithms presented in FIGS. 4-36.

TABLE 1
Alerts

| Alert | | Alert | Alert | |
|---|---|---|---|---|
| Code | Alert Type | Value | Priority | Alert Description |
| C1 | Counseling | 1 | | HAART candidate, not psychologically ready for therapy |
| C2 | Counseling | 2 | | Not medically eligible for any regimen |
| C3 | Counseling | 3 | | Not compliant in taking cotrimoxazole |
| C4 | Counseling | 4 | | Missed 2 or more appointments |
| C5 | Counseling | 5 | | Malnutrition requiring vitamin/mineral supplementation |
| C6 | Counseling | 6 | | Malnutrition requiring protein, vitamin/mineral |
| | | | | supplementation |
| C7 | Counseling | 7 | | Need Step-up adherence package |
| C8 | Counseling | 8 | | |
| HL1 | Healthy Living | 1 | | Drug literacy training needed - particular to each drug |
| HL2 | Healthy Living | 2 | | Adherence training needed |
| HL3 | Healthy Living | 3 | | Social worker consultation needed |
| HL4 | Healthy Living | 4 | | Home assessment needed |
| HL5 | Healthy Living | 5 | | |
| HL6 | Healthy Living | 6 | | |
| HL7 | Healthy Living | 7 | | TB prophylaxis |
| HL8 | Healthy Living | 8 | | |
| M1 | Medical | 1 | 1 | No medically suitable HAART regimen within guidelines |
| M10 | Medical | 10 | 1 | Virologic failure on 1^{st} line therapy |
| M11 | Medical | 11 | 1 | Consider 2^{nd} line therapy if adherence >80% |
| M12 | Medical | 12 | 1 | Virologic failure on 2^{nd} line therapy |
| M13 | Medical | 13 | 1 | Consider stopping HAART - palliative care |
| M2 | Medical | 2 | 1 | |
| M3 | Medical | 3 | 1 | Stop all HAART drugs, re-evaluated |
| M4 | Medical | 4 | 1 | |
| M5 | Medical | 5 | 1 | Signs of active TB |
| M6 | Medical | 6 | 1 | Active TB - requires treatment |
| M7 | Medical | 7 | 1 | Treat active TB - ensure HAART regimen does not |
| | | | | contain nevirapine |
| M8 | Medical | 8 | 1 | Complete at least 2 weeks of TB treatment, then start |
| | | | | HAART - no nevirapine |
| M9 | Medical | 9 | 1 | Complete at least 2 months of TB treatment, then start |
| | | | | HAART - no nevirapine |
| O1 | Operational | 1 | 1 | Already on HAART - outside of pilot parameters |
| O2 | Operational | 2 | 1 | Labs incomplete |
| O3 | Operational | 3 | 1 | Not an adult - outside of pilot parameters |
| O4 | Operational | 4 | 1 | Labs incomplete - need viral load to assess regimen |
| | | | | effectiveness |
| O5 | Operational | 5 | 1 | Labs incomplete - need TB sputum result |
| O6 | Operational | 6 | 1 | Labs incomplete - need TB skin test result |
| R01 | Report | 1 | 9 | HIV status confirmed |
| R02 | Report | 2 | 5 | HAART candidate - meets medical criteria |
| R03 | Report | 3 | 1 | Not HAART candidate - does not meet medical criteria |
| R04 | Report | 4 | 5 | HAART candidate - meets compliance criteria |
| R05 | Report | 5 | 1 | Not HAART candidate - does not meet compliance |
| | | | | criteria |
| R06 | Report | 6 | 9 | (Name of flow) unknown |
| R07 | Report | 7 | 9 | (Name of flow) within normal limits |
| R08 | Report | 8 | 5 | (Name of flow) - mild impairment |
| R09 | Report | 9 | 1 | (Name of flow) - moderate impairment |
| R10 | Report | 10 | 1 | (Name of flow) - severe impairment |
| R11 | Report | 11 | 9 | Nutrition within normal limits |
| R12 | Report | 12 | 5 | Psych history |
| R13 | Report | 13 | 1 | Eficarenz contraindicated |
| R14 | Report | 14 | 5 | Unreliable contraception |
| R15 | Report | 15 | 9 | No contraindications to Efivarenz |
| R16 | Report | 16 | 1 | Nevirapine contraindicated |
| R17 | Report | 17 | 5 | Nevirapine resistance proven |
| R18 | Report | 18 | 5 | Skin rash - moderate/severe |
| R19 | Report | 19 | 9 | No contraindications to nevirapine |
| R20 | Report | 20 | 1 | Didanosine contraindicated |
| R21 | Report | 21 | 9 | No contraindications to didanosine |
| R22 | Report | 22 | 5 | Peripheral neuropathy moderate/severe |
| R23 | Report | 23 | 9 | No contraindications to stavudine |
| R24 | Report | 24 | | |
| R25 | Report | 25 | 1 | Zidovudine contraindicated |
| R26 | Report | 26 | 9 | No contraindications to zidovudine |
| R27 | Report | 27 | 1 | Lopinavir/ritanovir contraindicated |
| R28 | Report | 28 | 9 | No contraindications to Lopinavir/ritanovir |
| R29 | Report | 29 | | |
| R30 | Report | 30 | 5 | WHO Clinical Stage 4 |
| R31 | Report | 31 | 1 | Pregnant |
| R32 | Report | 32 | 1 | May be pregnant |
| R33 | Report | 33 | 5 | Outside weight/age parameters for Efivarenz |
| R34 | Report | 34 | 5 | Outside weight/age parameters for Lopinavir/Ritanavir |
| R35 | Report | 35 | 1 | HIV status not confirmed |
| R36 | Report | 36 | 5 | Creatinine clearance too low for Stavudine |
| R37 | Report | 37 | 1 | Stavudine contraindicated |
| R38 | Report | 38 | 5 | Outside age parameters for Nevirapine |
| R39 | Report | 39 | 5 | Malnutrition - mild/moderate |
| R40 | Report | 40 | 5 | Malnutrition - severe |
| R41 | Report | 41 | 5 | Sputum negative for TB |
| R42 | Report | 42 | 5 | TB prophylaxis >9 months |
| R43 | Report | 43 | 5 | Isoniazid contraindicated - status liver |
| R44 | Report | 44 | 5 | TB prophylaxis not indicated - on HAART |
| R45 | Report | 45 | 5 | Isoniazid contraindicated - treated for active TB in past |
| | | | | 2 years |
| R46 | Report | 46 | 5 | TB prophylaxis no indicated |
| R47 | Report | 47 | 5 | TB prophylaxis start date unknown |
| R48 | Report | 48 | 5 | TB prophylaxis indicated |
| R49 | Report | 49 | 5 | TB skin test positive |
| R50 | Report | 50 | 1 | Get TB skin test |
| R51 | Report | 51 | 5 | Non-reactive TB skin test |
| R52 | Report | 52 | 1 | Get sputum for TB smear and culture |
| R53 | Report | 53 | 1 | TB prophylaxis complete - 6 month supply within 9 |
| | | | | months |
| R54 | Report | 54 | 1 | Complete TB treatment, then evaluate for HAART |
| R55 | Report | 55 | 5 | Active TB treatment start date unknown |
| R56 | Report | 56 | 5 | One viral load >5,000 |
| R57 | Report | 57 | 1 | Low level viremia (400–5,000) |
| R58 | Report | 58 | 1 | Clinical evidence of 2^{nd} line therapy failure |
| R59 | Report | 59 | 9 | No contraindications to Isoniazid |
| R60 | Report | 60 | 1 | Mismatch between previous and current status |
| R61 | Report | 61 | 5 | No signs of active TB |
| R62 | Report | 62 | 5 | Cotrimoxazole prophylaxis not indicated |
| R63 | Report | 63 | 5 | Cotrimoxazole prophylaxis indicated |
| R64 | Report | 64 | 5 | Currently on Isoniazid |
| R65 | Report | 65 | 5 | Height not recorded - BMI not calculated, nutrition |
| | | | | status unknown |
| S0W | Schedule | | | Emergency callback (0 weeks) |
| S11W | Schedule | | | 11 weeks |
| S12M | Schedule | | | 12 month |
| S12W | Schedule | | | 12 weeks |
| S15W | Schedule | | | 15 weeks |
| S16W | Schedule | | | 16 weeks |
| S1M | Schedule | | | 1 month |
| S1W | Schedule | | | 1 week |
| S23W | Schedule | | | 23 weeks |
| S24W | Schedule | | | 24 weeks |
| S2M | Schedule | | | 2 months |
| S2W | Schedule | | | 2 weeks |
| S3M | Schedule | | | 3 months |
| S3W | Schedule | | | 3 weeks |
| S4M | Schedule | | | 4 months |
| S4W | Schedule | | | 4 weeks |
| S5M | Schedule | | | 5 months |
| S6M | Schedule | | | 6 months |
| S7W | Schedule | | | 7 weeks |
| S8W | Schedule | | | 8 weeks |

Data input into the system of the present invention can be achieved using methods including, but not limited to, computers, hand-held devices such a personal digital assistant (PDA), or paper forms. The data is then transmitted to the computer server using methods including, but not limited to, dial up systems using phone lines, wireless systems or direct connections.

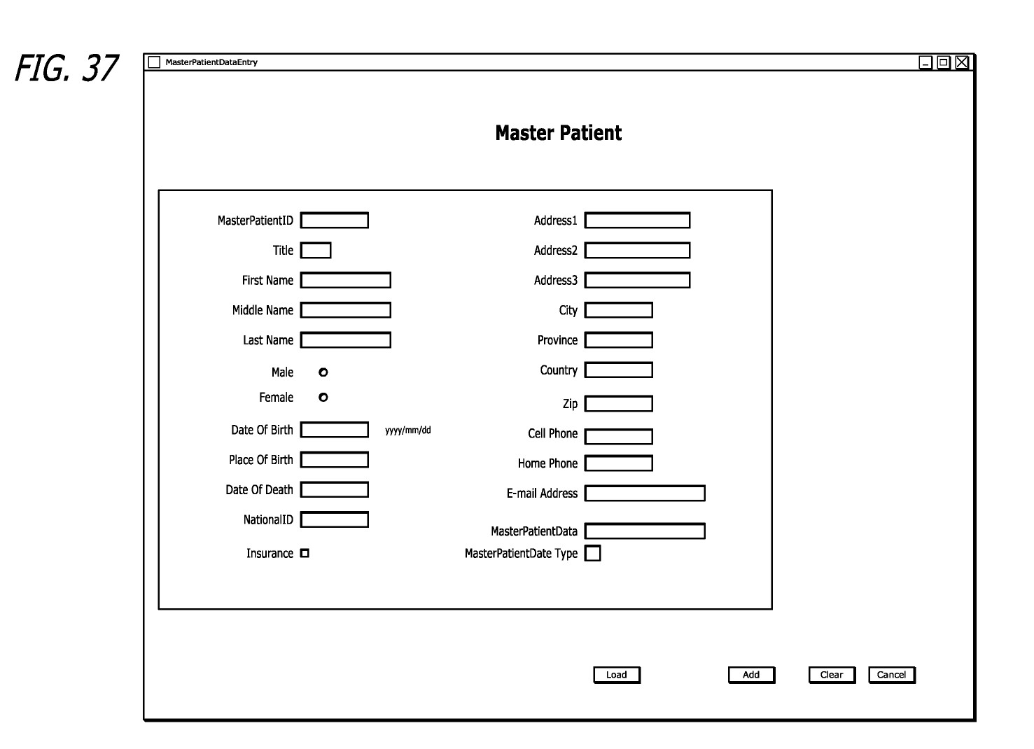

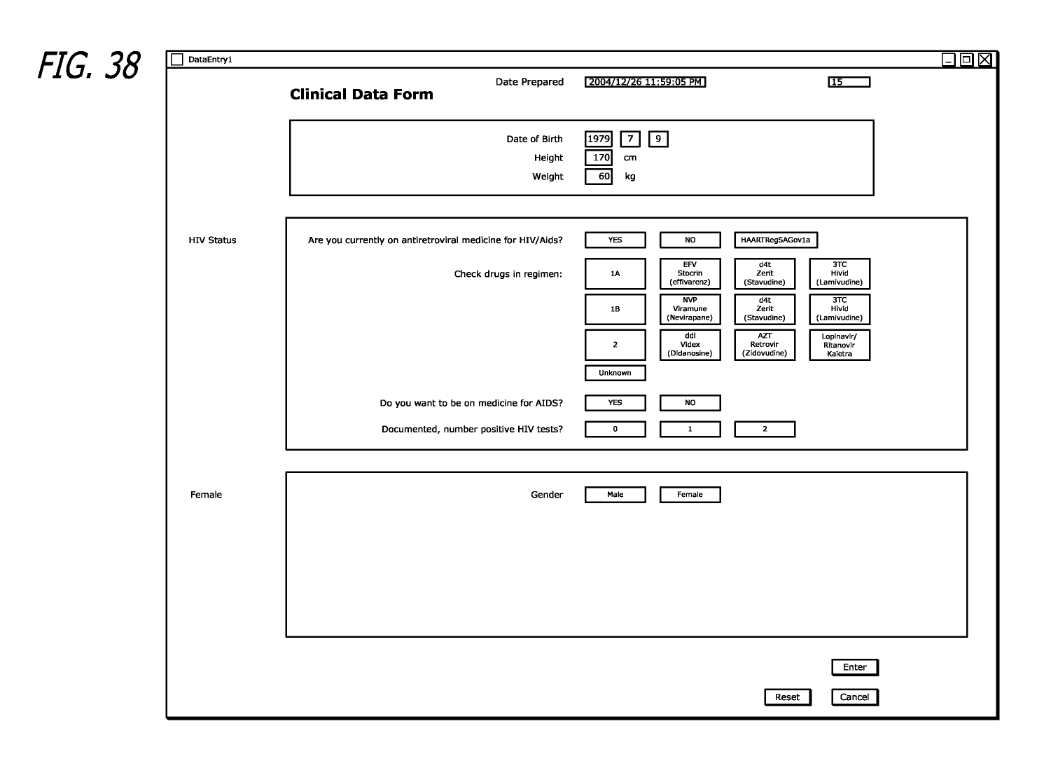

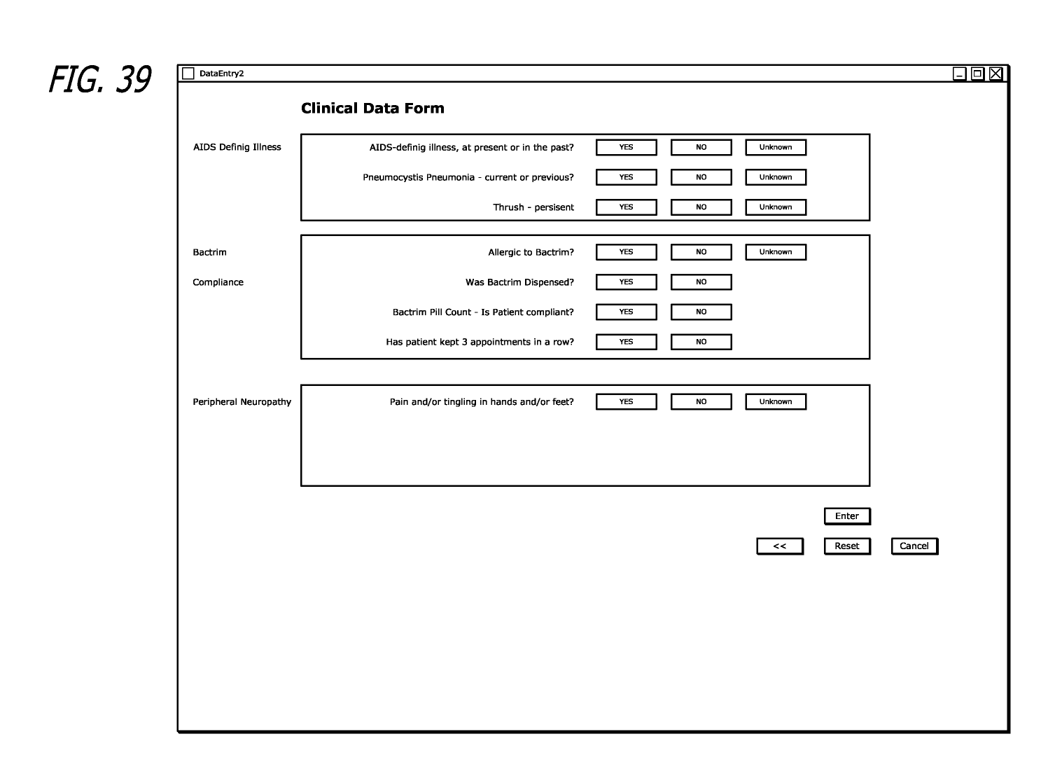

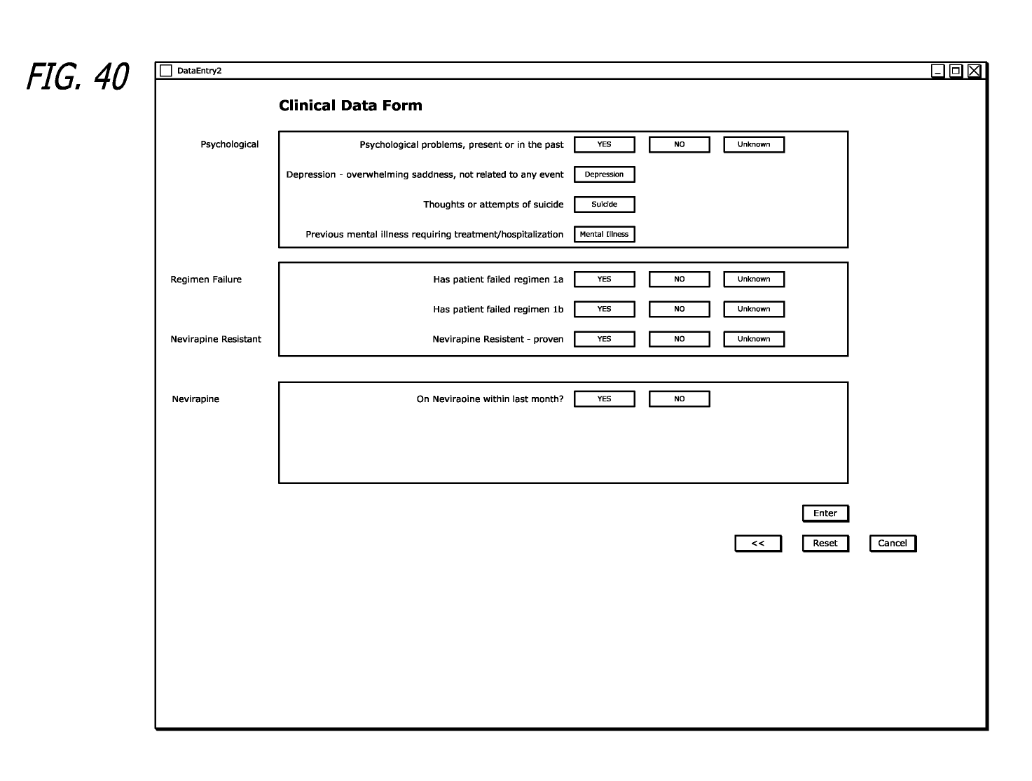

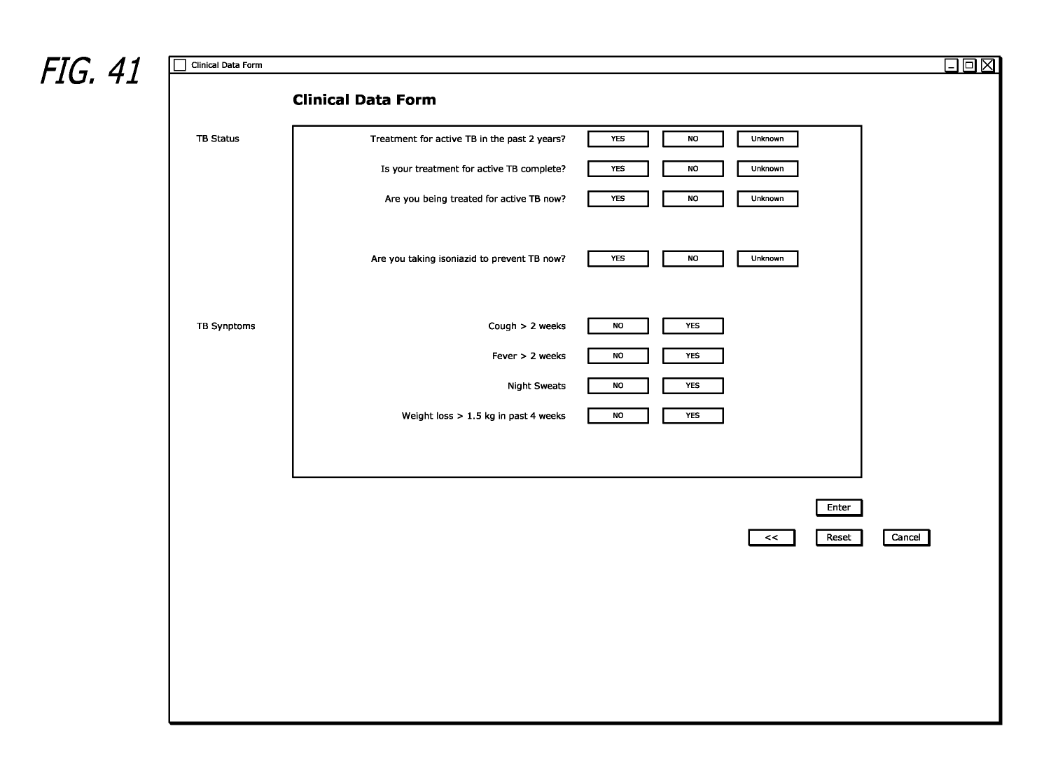

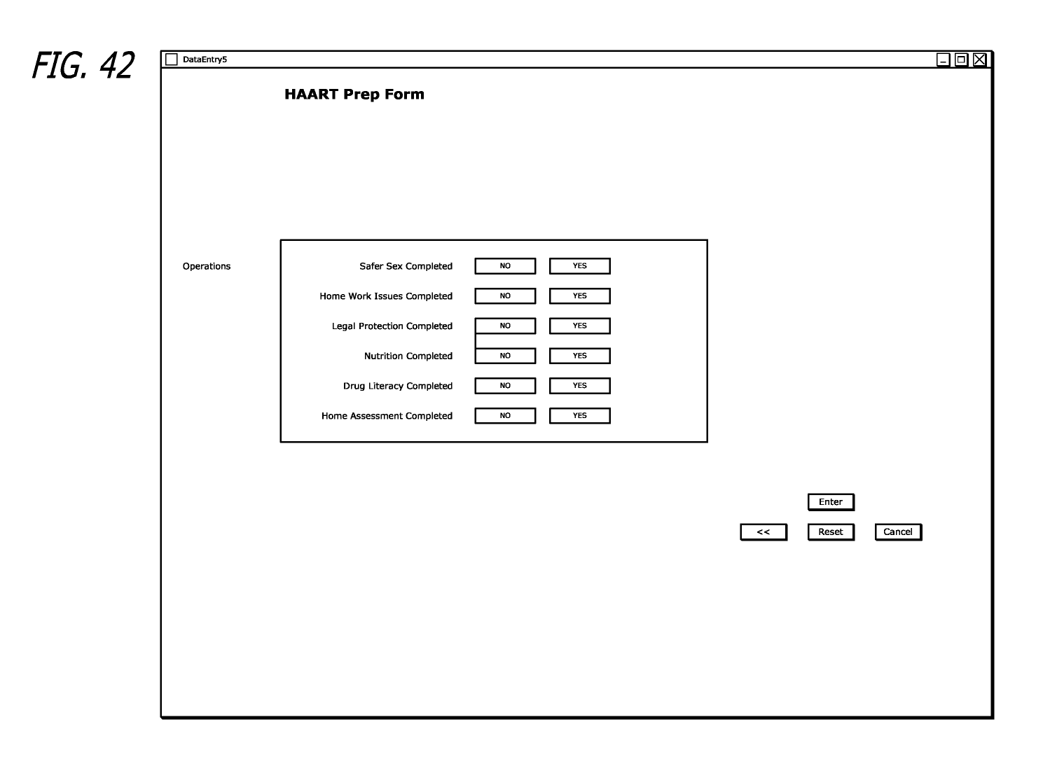

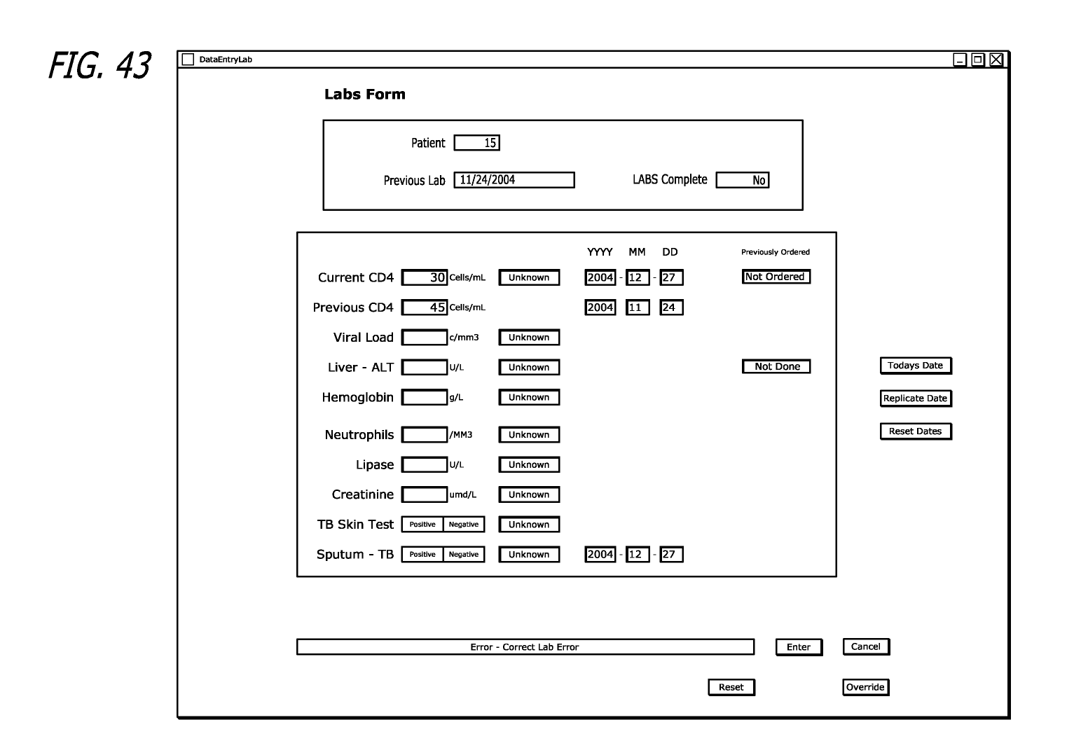

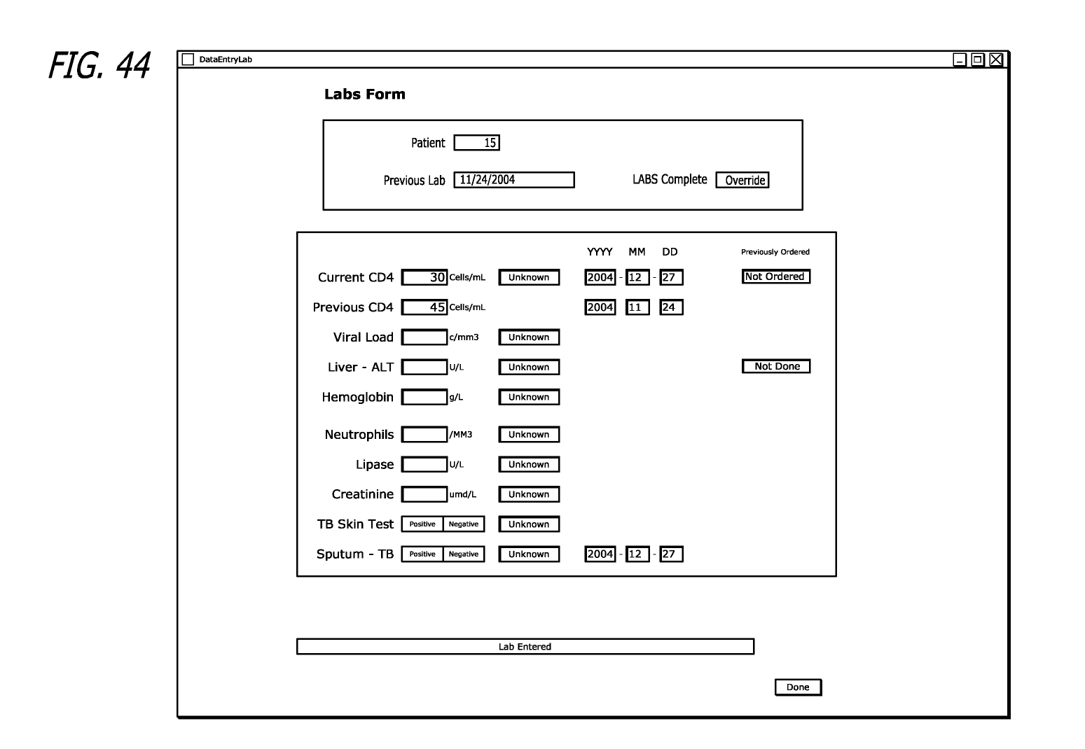

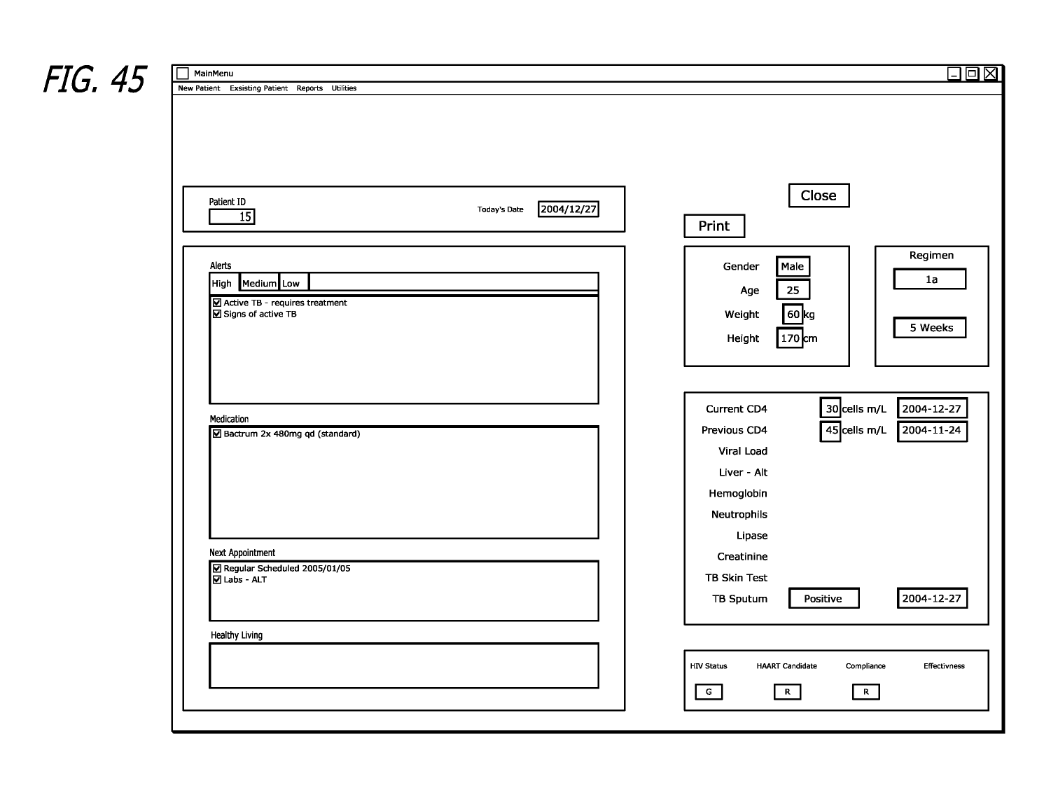

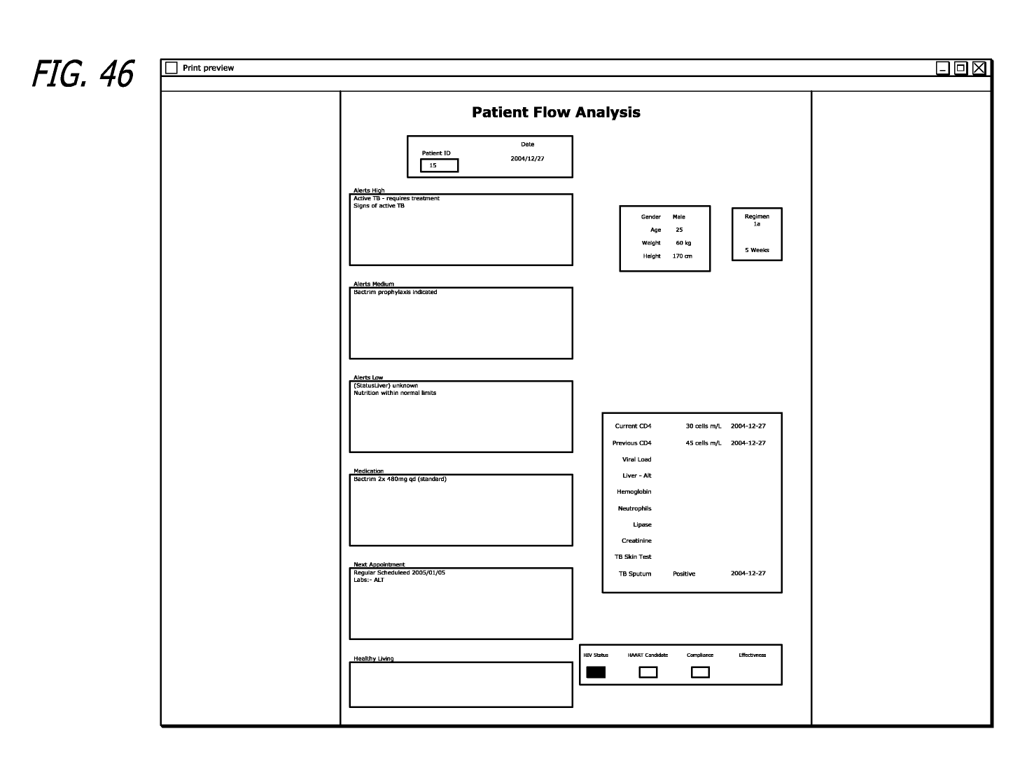

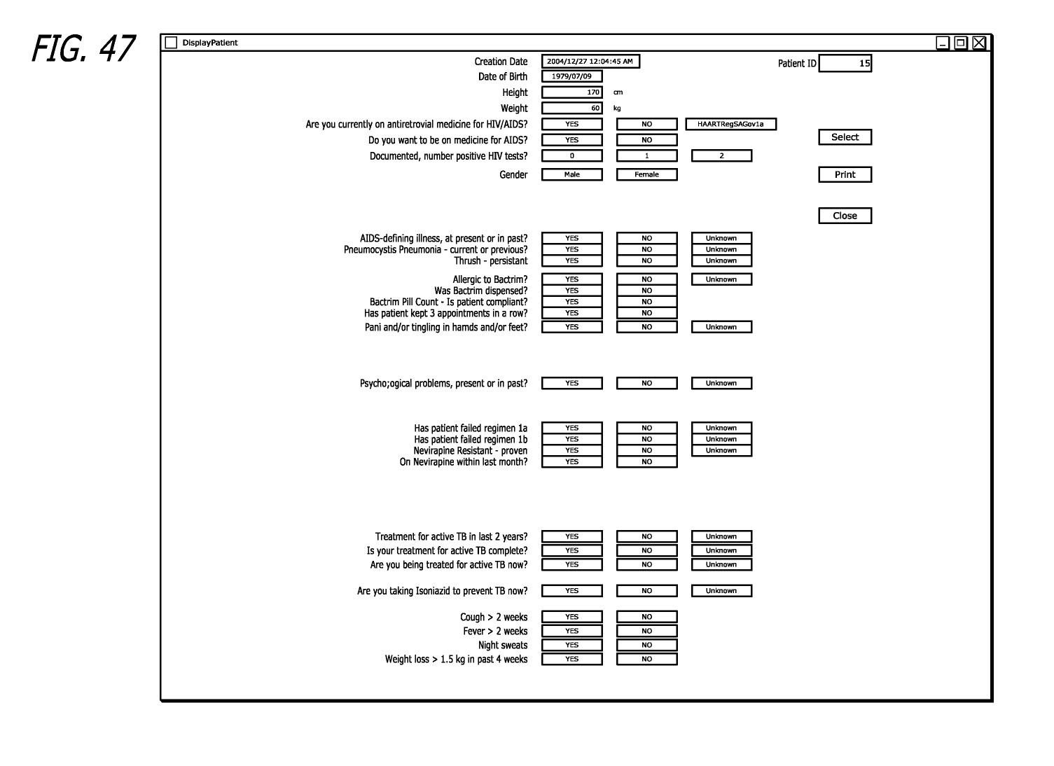

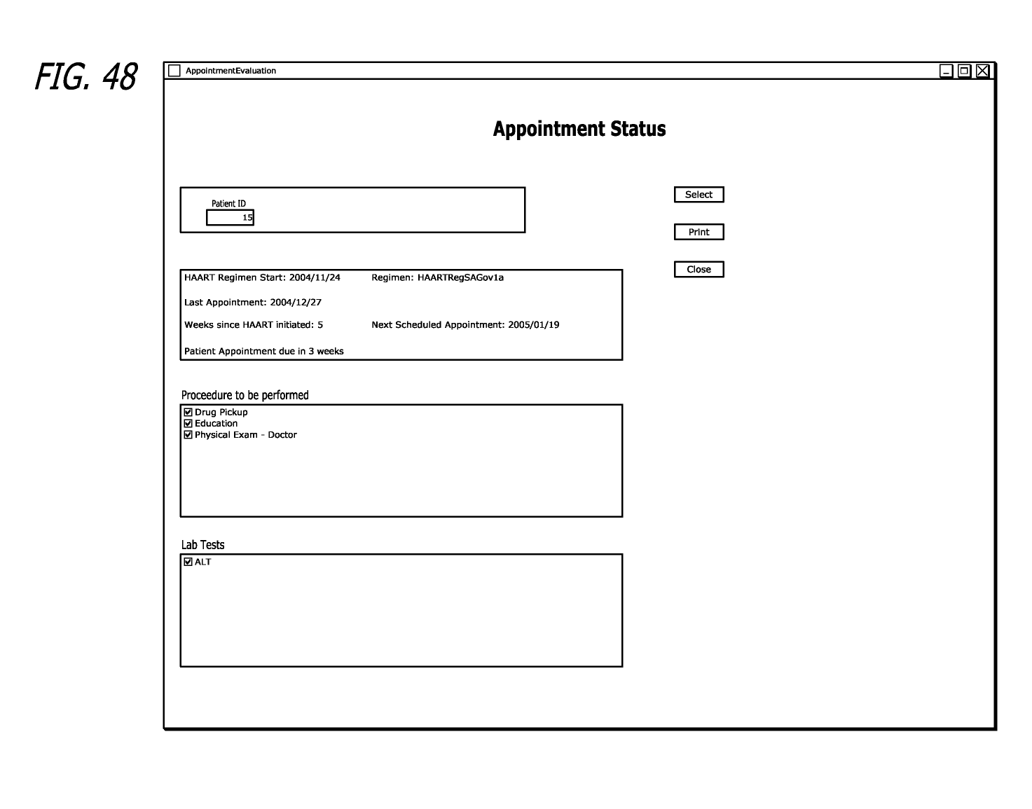

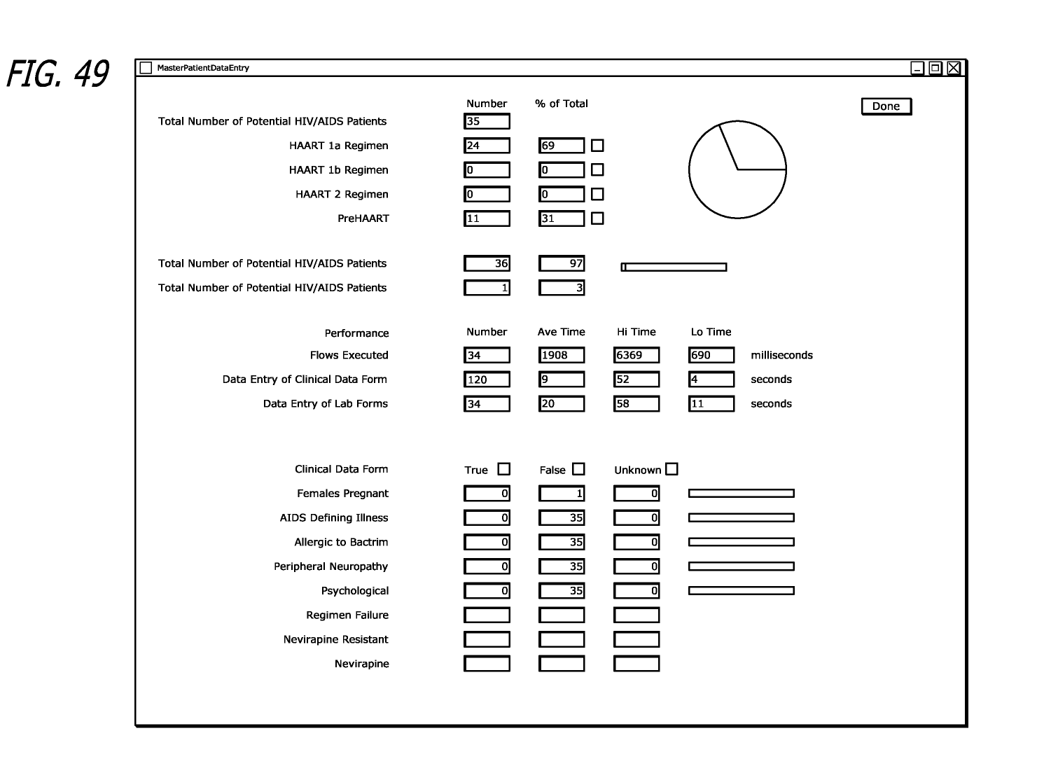

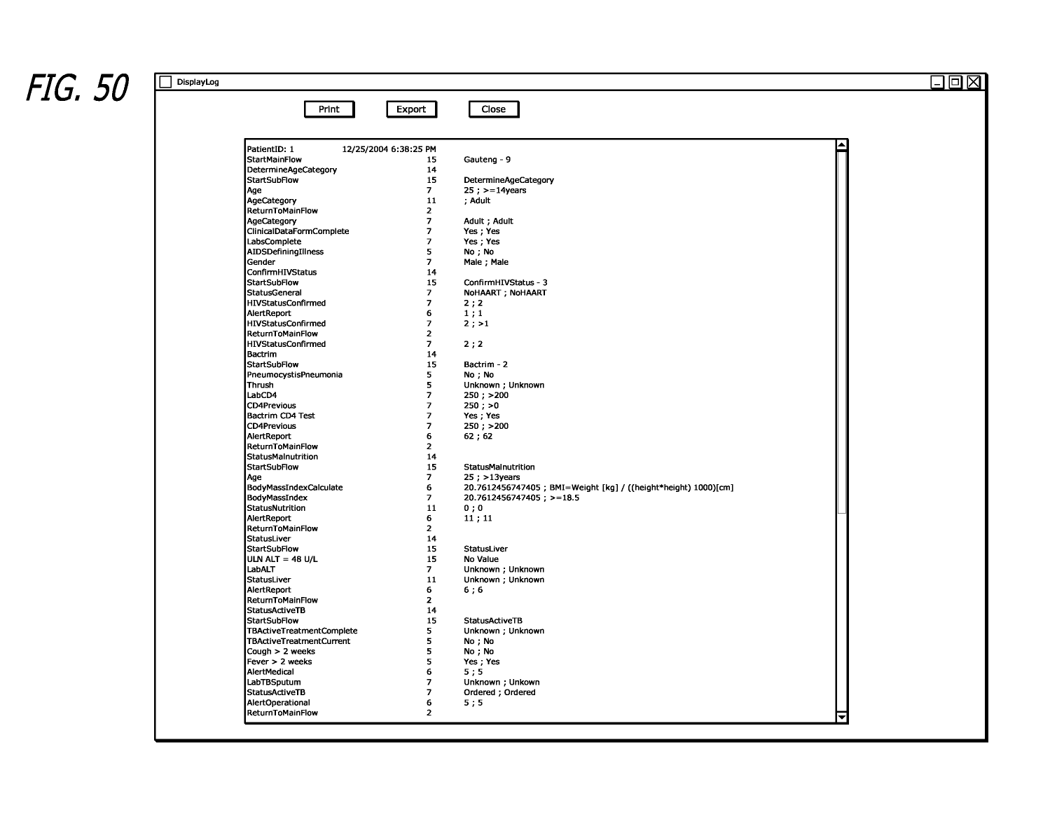

When data input into the system of the present invention is achieved using a computer, system-specific computer screen forms are used. Exemplary screen shots can be found in FIGS. 38-51.

The algorithm of the disease management system of the present invention's statistical evaluation center contains many novel and proprietary elements. The process of utilizing mathematical algorithms developed from statistical and empirical input to forecast outcomes is well known in the art, and is often used in various areas of economic activity, including healthcare. The algorithm-based system of the present invention, however, is uniquely applied, in an illustrative example, to the treatment of HIV/AIDS patients, together with associated diseases such as TB and malaria. Whereas disease modeling has typically been used in the past to provide guidance only to professionals, the system of the present invention will provide actual diagnosis of patients, as well as prescription of the applicable medicine regime.

The system of the present invention would therefore provide an information technology-based functionality that enables a lower level healthcare worker to treat patients with a high level of certainty, comparable to experienced HIV/AIDS doctors and specialists. The system of the present invention is therefore more advanced than known disease treatment systems which merely provide guidance. The system of the present invention, for example, may contain various levels, or parameters, of safeguards to protect patients, and only patients that can be safely treated within a high level of certainty would be directly treated. Patients that fall outside the safe parameters of the model would be referred to an HIV/AIDS specialist. This may occur at a tertiary hospital, by consultation within the algorithm cycle, or in real time via mobile phone, SMS or other appropriate technology. However, all referrals will be monitored by the system, and the outcomes of assessments by specialists would continually be used to upgrade the system algorithm of the present invention. This enables the system of the present invention to adjust the safety parameters to treat more patients directly and thereby reducing costs as well as improves the service to patients.

It is to be expressly understood that the claimed invention is not to be limited to the description of any single embodiment but encompasses other modifications and alterations within the scope and spirit of the inventive concept.

We claim:

1. A human immunodeficiency virus (HIV)-related disease management system comprising:
patient data comprising at least one type of data selected from the group consisting of physical examination data, laboratory data, and patient history data;
data interpretation means; and
therapeutic dispensing means, wherein said data collection means is used to obtain disease state information from a patient having an HIV-related disease wherein said patient is located remotely relative to said data interpretation means and said therapeutic dispensing means and wherein said data interpretation means is located on a computer-readable medium and provides diagnostic, prognostic and therapeutic information useful for the management of said HIV-related disease of said patient.

2. The disease management system of claim 1 wherein said data is collected by a non-physician healthcare worker or a laboratory.

3. The disease management system of claim 1 wherein said data interpretation means comprises the algorithm of FIG. 4.

4. The disease management system of claim 1 wherein said therapeutic dispensing means comprises a pharmacy.

5. The disease management system of claim 1 wherein said computer-readable medium is a selected from the group consisting of hard drives, floppy disks, CD-ROMs, zip drives and flash drives.

6. The disease management system of claim 1 wherein said HIV-related disease is acquired immune deficiency syndrome (AIDS).

7. An HIV-related disease management system comprising:
patient data comprising at least one type of data selected from the group consisting of physical examination data, laboratory data, and patient history data;
a data interpretation means for interpreting said data; and
a therapeutic dispensing means for providing therapy useful for treating said HIV-related disease, wherein said data comprises disease state information from a patient having a HIV-related disease wherein said patient is located remotely relative to said data interpretation means and said therapeutic dispensing means and wherein said data interpretation means is located on a computer-readable medium and provides diagnostic, prognostic and therapeutic information useful for the management of said disease of said patient.

8. The disease management system of claim 7 wherein said data comprises a patient history and CD4 levels.

9. The disease management system of claim 7 wherein the therapy comprises High Activity Anti-Retroviral Therapy (HAART).

10. A method for managing HIV-related disease in a patient located remotely relative to data interpretation means and therapeutic dispensing means comprising:
collecting a first set of data from said remotely located patient having an HIV-related disease;
interpreting said first set of data in order to determine an appropriate first therapeutic regimen for said remotely located patient;
dispensing said first therapeutic regimen to said remotely located patient;
collecting at least one second set of data from said remotely located patient;
interpreting said at least one second set of data in order to determine the appropriateness of continuing or stopping said first therapeutic regimen or altering said first therapeutic regimen for said remotely located patient; and
wherein said first and at least one second interpreting step comprises an algorithm located on a computer-readable medium that provides diagnostic, prognostic and therapeutic information useful for the management of said HIV-related disease of said patient.

11. The method for managing disease in a patient of claim 10 wherein said data is collected by a non-physician healthcare worker or a laboratory.

12. The method for managing disease in a patient of claim 10 wherein said data interpretation means comprises the algorithm of FIG. 4.

13. The method for managing disease in a patient of claim 10 wherein said therapeutic dispensing means comprises a pharmacy.

14. The method for managing disease in a patient of claim 10 wherein said computer-readable medium is a selected from the group consisting of hard drives, floppy disks, CD-ROMs, zip drives and flash drives.

15. A method for HIV-related disease management comprising:
collecting data from a patient;
interpreting data according to the algorithm of FIG. 4 such that a diagnosis is established and/or a treatment regimen is proposed; and
dispensing a therapeutic useful for treating said HIV-related disease in said patient based upon said diagnosis and/or said treatment regimen.
